(19) United States
(12) Patent Application Publication
(10) Pub. No.: US 2004/0054610 A1
(43) Pub. Date: Mar. 18, 2004

(54) Monetaire wealth management platform

(75) Inventors: Arnold E. Amstutz, Farmington, CT (US); Louis J. Miele, Upper Montclair, NJ (US); Michael Neff, Mill Neck, NY (US); Michael Kelleher, New York, NY (US); Damon W. Carr, New York, NY (US)

Correspondence Address: Alex C. Chartove, Morrison & Foerster LLP, Suite 300, 1650 Tysons Boulevard, McLean, VA, 22102, US

(73) Assignee: Monetaire, New York, NY

(21) Appl. No.: 10/304,015

(22) Filed: Nov. 26, 2002

Related U.S. Application Data
(60) Provisional application No. 60/333,528, filed on Nov. 28, 2001.

(51) Int. Cl. G06F 17/60

(52) U.S. Cl. 705/36

(57) ABSTRACT

A system and method facilitating financial advice delivery by linking product and service recommendations to objective financial advice. A generic abstraction of all strategic and tactical financial goal setting, analysis, funding and tracking elements into a set of distinct conceptual building blocks, which, in combination, provide a comprehensive representation of all aspects of balance sheet, income statement, cash flow and insurance planning and analysis. A proprietary Rule Builder Workstation governs all aspects of Wealth Management applications including business/financial advice logic, constants and user interface elements. Business rules controlling content, advice, and presentation format across multiple employee and customer facing applications are written and modified in an environment that enables business usurers to dynamically add or update rules without a new release of the software. A Computational Engine provides an object-oriented software abstraction of complex earnings/expense, balance sheet and cash-flow modeling through which all quantitative and statistical functions are performed. The Engine handles complex combinations of overlapping conditions and constraints, monetary inflow/outflow scenarios and multi-stage flows that change characteristics based on critical events delivering uniform advice consistent with Abstraction structures across all delivery channels. This software API uniquely encapsulates all attributes of, and relationships among, these processes in a single component. For example, it is possible to leverage Extensible Markup Language (XML) over the Hypertext Transfer Protocol (HTTP) or Hypertext Transfer Protocol Secure (HTTPS).

### FIELD OF THE INVENTION

The present invention relates to a system and method, which facilitates global financial advice delivery. Advice content, format and delivery modes are controlled through a software platform that enables firms using the invention to structure the business processes and underlying rules that determine the nature, context and presentation of advice delivered in multiple languages and currencies (locations).

By creating and modifying rules, the user of the invention easily controls all aspects of financial advice delivery across their organization insuring consistent and regulatory compliant investment sales and service processes. The Platform embodying the invention lets them quickly respond to changing market conditions, regulatory requirements, competitive actions and product/service capabilities.

### BACKGROUND OF THE INVENTION

Financial service providers globally are attempting to move from a “product push” to an advice based “consultative selling” approach to existing and prospective customers. Their goal is to be become “Wealth Managers” perceived as trusted financial advisors' rather than merely financial product sellers.

Their effort is driven in large part by increased consumer awareness of investment and financial issues and alternatives and associated demands for more ‘customer-centric/goal oriented’ relationships with financial service providers—banks, brokers, insurance companies, etc. For example, a consumer concerned about retirement wants a financial institution that can objectively help him or her: develop realistic goals; analyze alternative strategies and tactics; select from among appropriate portfolio structures and suitable products; and monitor progress in achieving the goal over time.

The invention solves the host of problems, discussed hereinafter, faced by financial institutions endeavoring to make this difficult transition to ‘Wealth Management’ or ‘Integrated Financial Planning’. The invention supports delivery of these services through individual financial advisors, call-centers, in branch Kiosks, and to customers directly through Internet, phone, fax and PDAs.

Further, the present invention overcomes limitations of the prior art, which requires software modifications to change business processes, advice content or delivery processes. The present invention, unlike prior art devices, allows subject matter experts and business managers to change processes and rules themselves, without manual software modifications dramatically reducing the time and cost to effect changes.

Financial service providers across the globe must solve seven major problems directly addressed by the invention. Financial Service Providers (FSPs) face increasing regulatory compliance challenges and related business risks that must be addressed rapidly to maintain growth trajectories and avoid potentially serious litigation. These include implementing stringent “Know Your Customer” (KYC) profiling rules, strict anti money laundering controls, and demanding investment suitability standards. Failure to comply with these requirements can result in costly criminal as well as civil litigation and put managers at personal risk of penalties including monetary fines and jail sentences.

Financial service customers exhibit significant relationship inertia, tending to stay with existing suppliers unless given a reason to change, however, they are not intrinsically loyal to current providers. To retain and extend current customer relationships, acquire new ones and increase “share of wallet”, FSPs must find positive ways to sensitize customers and prospects to the quality, breadth and appropriateness of offered services. They must also demonstrate their ability to responsively remedy observed shortcomings and consistently introduce new high-value services.

FSPs currently offer limited investment and credit options structured, at best, around a small number of simple, one-size-fits-all-model, portfolios. These structures ignore the distinct needs and preferences of customers in different economic strata, market segments and geographic regions with varying levels of sophistication and financial interests. Customers are sold individual products and standardized “cookie cutter” packages, which are at best, sub optimal and often totally inappropriate.

New business acquisition and existing relationship expansion are severely limited by traditional “single product push” sales approaches which are based on “one size fits all” financial plans and communications. Such systems fail to address customer needs and miss opportunities to profitably address significant customer problems. Efforts to develop comprehensive customer need-based solutions are hindered by the limited breadth and depth of sales person knowledge as well as cost and organizational constraints that preclude product specialist involvement in all but the largest customer accounts. Further, recommendations tailored to individual customer needs introduce a plethora of regulatory compliance risks and tracking problems inherent in manual, or semi-automated, non-standard customer communication.

Some financial firms, particularly insurance companies, have successfully used “Financial Plans” to motivate the sale of a single product, e.g. life insurance. However, the plan makes little or no contribution beyond this single initial transaction. The drawback of prior art systems, such as this, is their inability to extend existing customer relationships by addressing strategic and tactical needs, identified in the plan through a series of transactions driven by customer priorities and preferences.

Efforts to achieve customer goals are hampered by the previously noted sales force attraction to new customers, and recently surfaced opportunities, as well as the logistics of maintaining, and sequentially executing, a multi-issue strategy involving a variety of products in a consistent and objective fashion.

FSP sales effectiveness and profitability are limited by traditional “sell 'em and leave 'em” sales tactics under which commission salesmen pressure a prospect or customer to buy one or more products, pocket the commission and move on to the next victim. It is widely accepted that expanding existing customer share of wallet by increasing established relationships is far more cost effective than making the first sale to a new customer. Nevertheless, traditional “dial and smile” sales processes emphasize this sub-optimal behavior.

The primary justification for this counter productive selling behavior and unproductive resource allocation is the extreme difficulty, if not impossibility, of setting, addressing and tracking against customer objectives using traditional sales systems. Ad hoc, one time, product transactions are much easier to execute then on-going, goal-oriented, financial programs tailored to customer needs and preferences.

The most common FSP customer complaint is, “My banker (or broker) never calls me.” Recognizing that effective relationship building requires on going customer-centered communication and ignored customers are highly susceptible to competitive overtures promising the interest and attention lacking in current relationship, management urges bankers, brokers and other agents to proactively communicate.

Sales people protest that responding to current problems, answering incoming calls and pursuing “hot leads” leave no time for proactive, outgoing communication and the time and dollar cost of preparing customer-specific messages is prohibitive.

Most Financial Service Providers (FSPs) are striving to establish their brand identity as a trusted advisor. In seeking this elusive goal, they now provide advice in many forms through diverse channels without considering the quality and consistency of the advice or whether they are profiting from delivering it. The platform allows them to generate profits by linking asset and liability product and service recommendations and sales to appropriate advice tailored to customer needs and preferences across wealth segments and distribution channels.

The benefits of the present invention are experienced by all value chain constituents who have a stake in the success of wealth management efforts. The remainder of this section describes benefits provided by the present invention, to each member of the chain.

One advantage of the present system over the prior art is that those persons responsible for face to face customer interactions never have to explain to a customer why another person or channel gave them a different answer to the same question—single platform serves all. They will also benefit from the experience of subject matter experts and best practices embodied in the Rule Builder Workstation knowledge base; gain increased efficiency from self-service Internet module identification and referral of sales opportunities, integrated data base and relationship support.

Further, the present invention functions more effectively than prior art systems, due to system supported goal formulation, strategy evaluation, proposal generation, product selection and plan monitoring; avoid routine communication, which is automated, leaving time to focus on productive relationship building and sales generation; offer more comprehensive, suitable and regulatory compliant advice to more customers through customer-centered problem definition and solution; cross-sell more products in more situations through goal-oriented in context links to CRM, back office and fulfillment/transaction systems; and position themselves as objective knowledgeable advisors (not product pushers) through customized platform-based analysis and recommendation

Moreover, those responsible for managing advice delivery channels can be confident their employees consistently deliver appropriate Wealth Management advice and recommendations tailored to customer needs; eliminate the majority of manual compliance reviews, which are replaced by system-based tracking and referral of unusual or questionable situations; replace personal review and approval of ad-hoc customer communication with expert system generated content driven by pre-approved decision rules, achieve major productivity gains from platform-assisted online customer/representative collaboration with fewer staff serving more customers; and reduce support staff training needs through expert-system driven platform “wizard” guidance, help functions and hyperlinked explanations.

The present invention also improves shrink sales training and coaching expenses by augmenting or replacing human advice and service delivery with platform guided interactions.

Senior managers—CEOs, CFOs and Sales/Marketing heads are able to migrate massive independent operating and support systems to a common flexible Platform integrating customer facing advice; deliver across channels; review and rationalize key business rules that drive customer communication, financial advice and product recommendations across all channels, apply best practices of the most experienced and effective subject matter experts, investment professionals and sales people to all customer situations, provide consistent application of regulatory compliance and internal audit standards to all advice, recommendations and customer communication, identify and act on significant product, market segment and individual customer revenue expansion and expense reduction opportunities, and gain competitive advantage by using the present Platform to rapidly modify advice, offerings and communications in response to market changes.

Those supporting sales, marketing, product and corporate management will be able to identify actionable opportunities to increase profits by expanding sales and marketing effectiveness, reducing costs and improving productivity; evaluate the profitability and growth potential of product lines, market segments, demographic groups and significant customers; build and expand a knowledge base institutionalizing best investment, credit, marketing communications, customer relations and sales practices; track interactions across channels linking and evaluating customer relationship, product, sales/marketing program and financial data.

Investment and credit product managers will be able to: maintain current information on products to insure consistent persuasive presentation to customers with needs for which they are suitable; develop new offerings to meet currently unsatisfied needs with suitable and appropriate products providing benefits customers are known to value; maintain and revise business rules controlling goal-specific advice content and product/service recommendations matched to customer risk tolerances; combine proprietary and third party product offerings to deliver appropriate cost effective solutions to the full range of customer needs; build on Abstractions provided by the present as a starting point for creating Rule Builder Workstation advice logic tailored to their customers and corporate priorities; track product/service performance against customer strategic and tactical goals with automatic Rule Builder Workstation-driven remedial recommendations.

Customers served by Financial Service Providers using the present Platform will be able to: enjoy a customized “finance central” where they can view and quickly assess their consolidated financial situation without massive data entry; access banking, brokerage and loan account information integrated with strategic advice, tactical recommendations and tailored goal tracking; obtain personalized product recommendations appropriate to their financial situation and designed to maximize the probability of achieving their goals; experience seamless consistent advice, product and service delivery in all channels through which they interact with the institution using the present invention; monitor progress against their goals with timely alerts based on their criteria and proposals to adjust for changes in market conditions or their situation.

### PRIOR ART

Prior art forces FSPs to adapt organizational processes and rules to narrowly defined structures and the processes and controls supported by prior art. Prior art does not facilitates the customization required to support the unique advisory rules of a potential user. In the design process of our invention we recognized that this was a critical successes factor that we had to solve (and we have solved).

The problem created by prior technology is analogous to requiring a change in ‘off the shelf’ application software functions. An application user needing the modifications to meet his business requirements would need to ask the software vendor to alter program code to effect desired changes.

In contrast, the platform incorporating our invention lets users change fundamental application operating characteristics to meet their business requirements without requesting software developers to modify code. This eliminates the primary failure of prior art.

Prior art also fails to expose an API that can be leveraged in other environments effectively limiting use to very controlled situations. Our invention as implemented eliminates this constraint through the Computational Engine API and Rule Builder as described in Sections III.A. and B. below.

This permits a third party to add features of our invention to their offering through our API by simply making programmatic calls to, and receiving results from, our platform (through a SOAP interface). A Customer Relationship Management (CRM) application vendor, for example, can provide our retirement analysis functionality through their application's user interface by calling our API in the background. The CRM system user is not aware that, “behind the curtain,” the Monetaire platform is was providing the intelligence.

Implementing our API through a ‘Web Services’ model eliminates the need for physical proximity by using the Internet as the communication backbone of our API. Therefore a customer in, say Australia, can seamlessly and securely access a server running the present platform in London using the Internet and related security protocols (HTTPS and/or digital certificates).

Applications based on prior art can only be modified through ad-hoc programmer changes to system code. In contrast, the Rule Builder component of the invention permits massive customization without software developer involvement. Using the invention, non-technical business users communicate desired functionality through English language rules, which the invention converts to executable application code.

Prior art supports only discrete planning exercises in which each need is treated as a distinct problem unrelated to a holistic plan. This allows the same funds to be applied to multiple goals double-counting assets and ignoring resource allocation/priority setting issues critical to meaningful and realistic wealth planning.

Prior art relies on rigid proprietary “one size fits all” technologies that can not be tailored to individual FSP requirements or adapted to changing market and business conditions. A parallel lack of flexibility severely limits ability to link to, and share data and processes with, back office and other legacy systems.

Prior art has been developed by firms myopically concerned with the North American market. As a result, multi-currency, flexible language and regional compliance capabilities are non-existent.

Prior art is segmented by channel (in-branch, web, kiosk or call center) and market segment (low end retail, emerging wealth, affluent or high net worth) applications with no capacity to seamlessly move along either dimension.

Prior art utilization of rigid ad-hoc XML/data models precludes generalized customer relationship, market segment, product and advice area representation and complicates, if not prohibits, system refinement and expansion. Prior Art can not link goals, advice, recommendations or customer interactions to Assets Under Management, sales, revenues, profits, customer acquisition, business retention and expansion or other measures of wealth management effects on business performance.

### SUMMARY OF THE INVENTION

The invention provides a system and method facilitating financial advice delivery in compelling, and previously unachievable, ways.

The invention helps Financial Service Providers generate incremental sales by linking product and service recommendations to objective financial advice. The present Wealth Management Platform incorporating the invention supports personalized Wealth Management in all wealth segments, over individuals' lifetimes, across customers' balance sheets and income statements. This lets FSPs differentiate themselves by offering consistent, personalized, comprehensive advice through all customer interaction channels.

The invention fully supports the “web Service” model by exposing invention-based functionality using industry standard technologies such as XML and HTTP over a computer network simplifying invention integration with other software applications and providing flexible communication with other systems.

At the core of the platform is a proprietary Rule Builder Workstation, which governs all aspects of Wealth Management applications including business/financial advice logic, constants and user interface elements. Business rules controlling content, advice, and presentation format across multiple employee and customer facing applications are written and modified in an environment that enables business usurers to dynamically add or update rules without a new release of the software.

To speed implementation, the invention has been used to develop reference user interfaces (UIs) that are completely customizable to FSP branding and proprietary business rules. These working “abstractions” include internal employee-facing applications ranging from retail to private bank as well as customer self-service via the Internet.

The investment gives Financial Service Providers the ability to identify plan for and track their customer's life events and financial needs while continuously documenting all planning conditions and assumptions.

Financial needs handled by the platform incorporating the invention include, but are not limited to: retirement, education, major purchase, wealth building, insurance, and debt management. Tactical advice modules allow customers or their advisors to develop goal definitions, formulate funding plans, and evaluate alternatives to achieve their goals. These can be treated as distinct goal-specific plans; or as components of a strategic lifetime plan. This allows users to begin with a simple advice exercise requiring minimal data input and expand to a comprehensive financial plan incorporating all prior elements.

The invention permits comprehensive strategic plans previously provided only to high net worth market segments, to be cost effectively offered to mass affluent and retail customers supplying a powerful base for relationship building across all wealth segments.

New life events and financial need modules are easily developed by assembling business rules in the Rule Builder Workstation—without coding. An abstracted model allows Monetaire or its customers to easily develop unique advice modules. It provides a framework to accept any set of funding streams, apply a variety of interest rate calculations, and generate periodic or one-time outflows.

The invention involves three tightly linked elements: the generic abstraction, the rule builder work station, and he computation engine.

The invention is based on a generic abstraction of all strategic and tactical financial goal setting, analysis, funding and tracking elements into a set of distinct conceptual building blocks, which, in combination, provide a comprehensive representation of all aspects of balance sheet, income statement, cash flow and insurance planning and analysis. Any type of financial situation and related analysis/recommendation generation can be described using these predefined components eliminating the need for ad-hoc definition, specification and coding.

The Rule Builder Workstation facilitates rapid representation and modification of business process, decision logic, advice delivery as well as customer communication content and format. Specified representations are error checked, displayed in case analysis displays and translated into executable code.

Rule Builder associated elements of the invention are implemented in four integrated components. 1. Relationship Definition Module, 2. Communication Module, 3. Code Generator, and 4. Data Maintenance Module

The Rule Builder Workstation's graphical relationship definition module permits business oriented subject matter experts rather than programmers to define processing rules, logic, constants and operating parameters. It facilitates rapid design and adaptation of criteria controlling Application process flow, advice delivery, content presentation sequence and GUI/Report content and format without coding.

The Rule Builder Workstation communication module lets business people produce presentations, letters, faxes, e-mails and alerts tailored to individual customer preferences. The module enables Marketing, Product and Sales units to implement proactive campaigns linked to customer resources, goals and interests based on flexible easily modified criteria. It encompasses full document construction including language, content, structure, style, and graphics tailored to individual customer situations, goals, priorities and preferences.

This capability dramatically improves advisor and organizational productivity by permitting highly individualized communications to be specified in standard templates. For example, a central group can develop ‘best practice’ letters and presentations incorporating customization rules for use by the entire organization leveraging the knowledge, experience and creativity of the firm's most effective communicators.

The Rule Builder Workstation's code generator converts Rule Definition and Communication Module outputs to fully functioning instruction sets enabling subject matter experts to create, test and install fully functioning systems without system developer or programmer involvement. The generator uses XML data structures to maximize the efficiency of cross-platform integration.

The code generator provides four unique benefits. Non-developers define, and significantly modify, platform software directly bypassing traditional software specification, design and programming processes. Rules are created and modified in a graphical interface that uses a ‘tree’ metaphor to represent logical precedence. To illustrate, the following logic snippet was created in the drag-drop graphical interface of the Rule Builder Workstation:

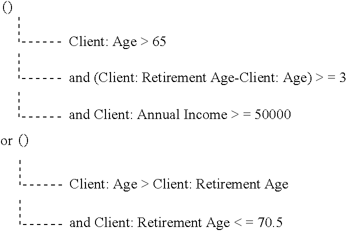

This converts to the following expression (shown in pseudo code): (Client: Age>65 and (Client: Retirement Age—Client: Age)>=3 and Client: Annual Income>=50000) or (Client: Age>Client: Retirement Age and Client: Retirement Age<=70.5).

Rules logic is maintained in a proprietary, abstracted format, which permits rule generation in any development language. The default implementation generates code as XML formatted Windows Script modules but code can also be generated in Java, C#, C++, COBOL, etc. This flexibility enables the invention to easily evolve to fit the ever changing technology landscape. Rules covering a complete range of wealth management application requirements are incorporated in the generator giving the invention unequalled financial services depth.

The Rule Builder Workstation maintains key data elements needed to automatically configure an application platform. System constants, pick list values, HTML insertions, questionnaire structures and scoring algorithms, asset type and class attributes, portfolio constructions, product characteristics, product/asset-type/-class maps cash flow, balance sheet, income and expense structures and any other financial concept are all created and maintained in the Workstation, packaged in an XML configuration document and transmitted to the platform instance.

The Computational Engine provides an object-oriented software abstraction of complex earnings/expense, balance sheet and cash-flow modeling through which all quantitative and statistical functions are performed. The Engine handles complex combinations of overlapping conditions and constraints, monetary inflow/outflow scenarios and multi-stage flows that change characteristics based on critical events delivering uniform advice consistent with Abstraction structures across all delivery channels.

This software API uniquely encapsulates all attributes of, and relationships among, these processes in a single component. The Engine can be implemented in a ‘Web Service’ environment to leverage Extensible Markup Language (XML) over the Hypertext Transfer Protocol (HTTP) using Simple Object Access Protocol (SOAPs).

This component of the invention overcomes limitations of prior art addressed in Section II.B and delivers the following benefits:

The invention's design, architecture and implementation are fully adaptable to user business processes, rules, standards and techniques. This includes screen flow ordering, logic, rules, screen colors and graphics, etc. The invention makes the Platform in which it is implemented the first offering to completely address the full range of global financial service industry needs.

By controlling all aspects of financial advice delivery including business logic, navigation, and user interfaces the Rule Builder establishes and maintains platform content and presentation format across multiple employee and customer facing channels in a “code-free” environment that converts graphical representations to executable code. This lets business users dynamically update rules in the production system without a new release of the software easily adapting to changing markets and business conditions.

The invention addresses the needs of entry level to ultra-affluent customers covering a full range of life events and attendant financial issues across both sides of the balance sheet (Assets, Liabilities and Owner's Equity) and encompasses unlimited investment and debt product/service offerings.

The invention is designed for global implementation and supports multiple currencies, languages (including Asian double-byte character sets), multi regional compliance and easily accommodates cross-border secrecy laws applicable to multi-country installations. (This is achieved though full Unicode compatibility.)

The invention delivers appropriate and suitable financial advice uniformly through in-branch, kiosk call centers and Internet ensuring consistency of communication and customer experience and seamless movement across all distribution channels. The invention is easily extension to cover access methods yet to be conceived.

The invention incorporates a comprehensive entity relationship and XML models that abstract linkages among data elements in a uniquely inclusive yet extensible structure. This proprietary logical design facilitates rapid initial customization and subsequent downward compatible modification of relationship, market segment, product, and advice representations.

The invention maintains a complete transaction record of customer interactions with the Platform through all channels. Goal elements, advice parameters, product recommendations and interaction patterns can be related to customer, product, business and market descriptors such as AUMs, sales, revenues, profits, acquisition and retention rates and all standard business performance measures.

### BRIEF DESCRIPTION OF THE DRAWINGS

FIG. 1 Invention—based Wealth Management Platform provides a high level illustration of invention-based Platform components

FIG. 2 Platform Functional Overview shows major functions of the invention and alternative delivery channel.

FIG. 3 Platform Internet Deployment illustrates computer hardware deployment for the invention use in an Internet environment.

FIG. 4 Platform Controller diagrams relationships among controller related workflow and software coordination for the invention.

FIG. 5 Rule Builder Architecture shows components of the Rule Builder and its implementation in a Wealth Management Platform.

FIG. 6 Normalizer Component explains run-time data transformation into a data structure supporting full reporting, MIS and analytics.

FIG. 7 Platform workflow illustrating internal operations of platform including rule builder, internal compliance and I.T. and eventual advice delivery through internal advisors and call center operators.

FIG. 8 Platform workflow illustrating parties outside the institution receiving financial advice through the Internet. Internal elements are included for reference to illustrate that the platform is the same for internal and external users.

FIG. 9—Example of Rule Builder life-cycle overview.

FIG. 10 Illustrative flowchart of six stages of invention-based platform use.

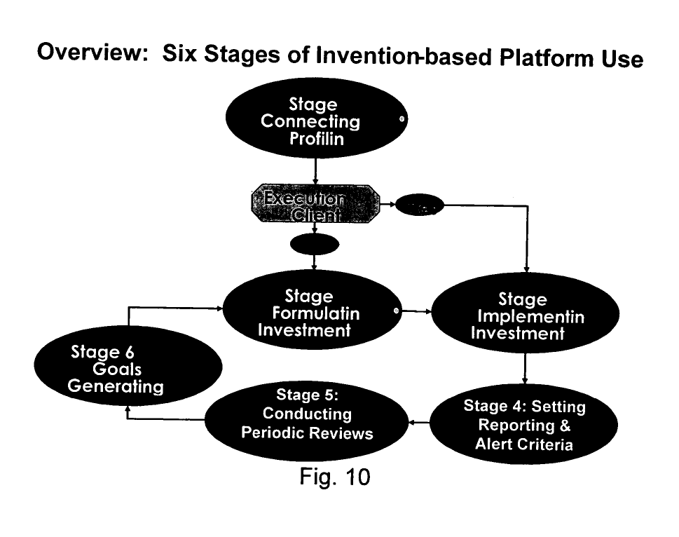

FIG. 11 Flowchart showing example of connecting and profiling stage of invention-based platform use.

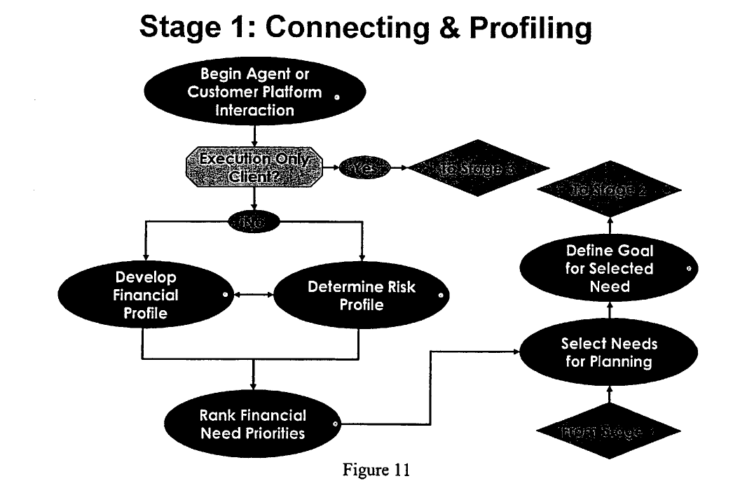

FIG. 12 Flowchart showing example of formulation of invention plan according to the invention-based platform use.

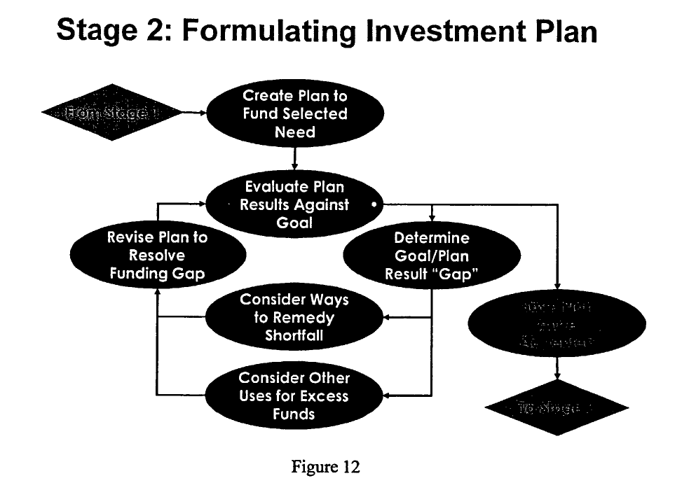

FIG. 13 Flowchart showing example of implementing an investment plan according to the invention-based platform use.

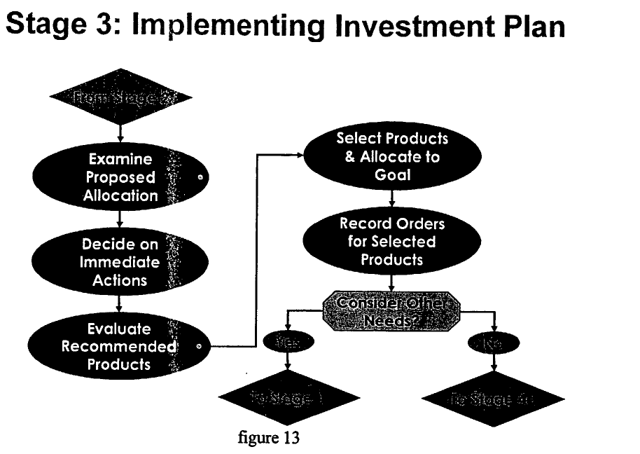

FIG. 14 Flowchart showing example of setting reporting and alert criteria of invention-based platform use.

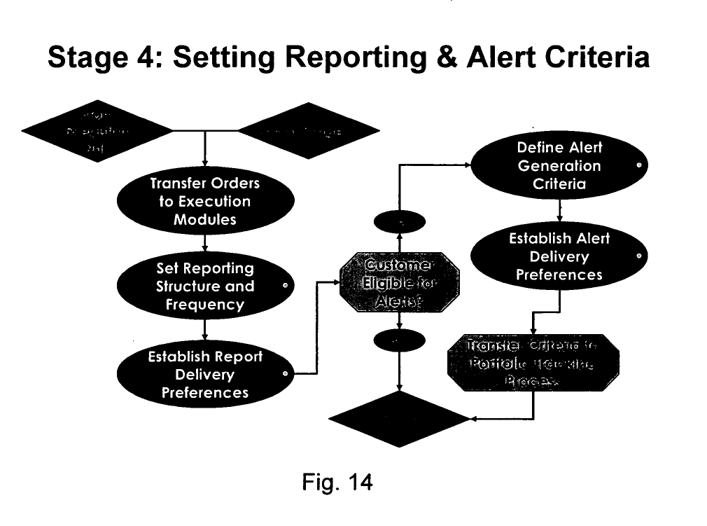

FIG. 15 Flowchart showing procedure for conducting periodic reviews according to invention-based platform use.

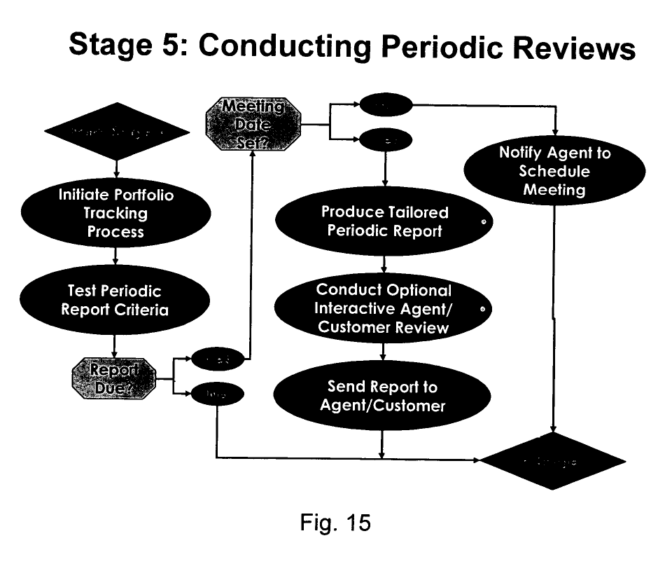

FIG. 16 Flowchart showing procedure for tracking goals and generating alerts according to invention-based platform use.

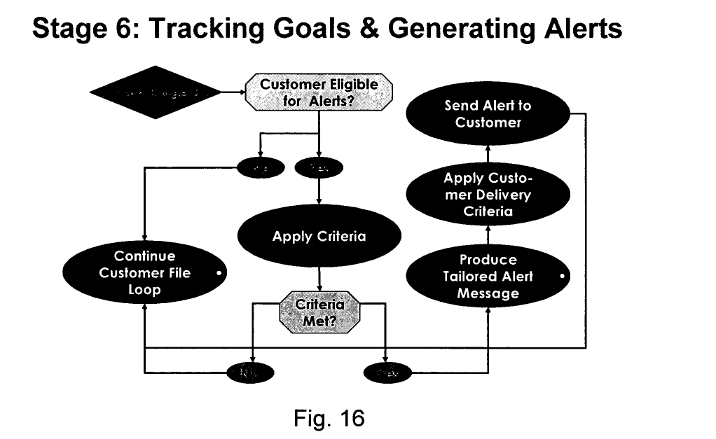

### DETAILED DESCRIPTION OF THE INVENTION

The present invention designed to facilitate financial advice delivery. It lets Financial Service Providers maintain advice rules that completely structure and control Wealth Management Platform functions without software development, giving them the ability to quickly define and modify financial advice, products and services across delivery channels.

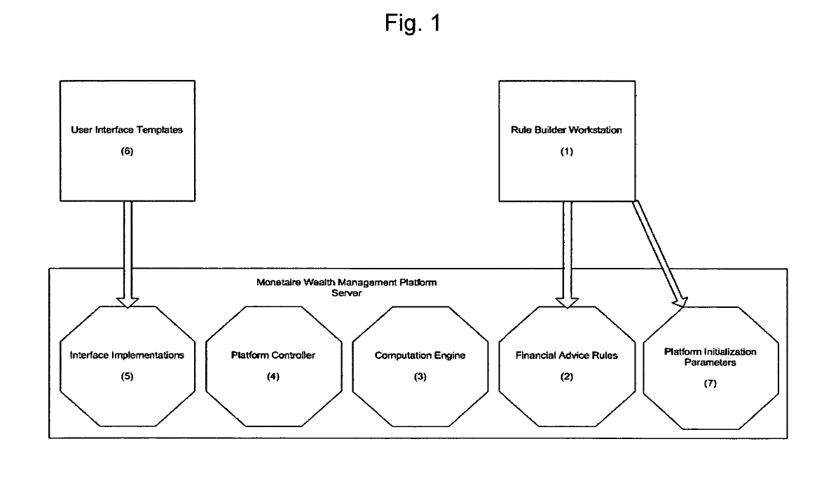

As shown in FIG. 1, an invention user (advice provider) employs the Rule Builder Workstation (1) to define a series of interrelated rules describing the desired advice delivery process.

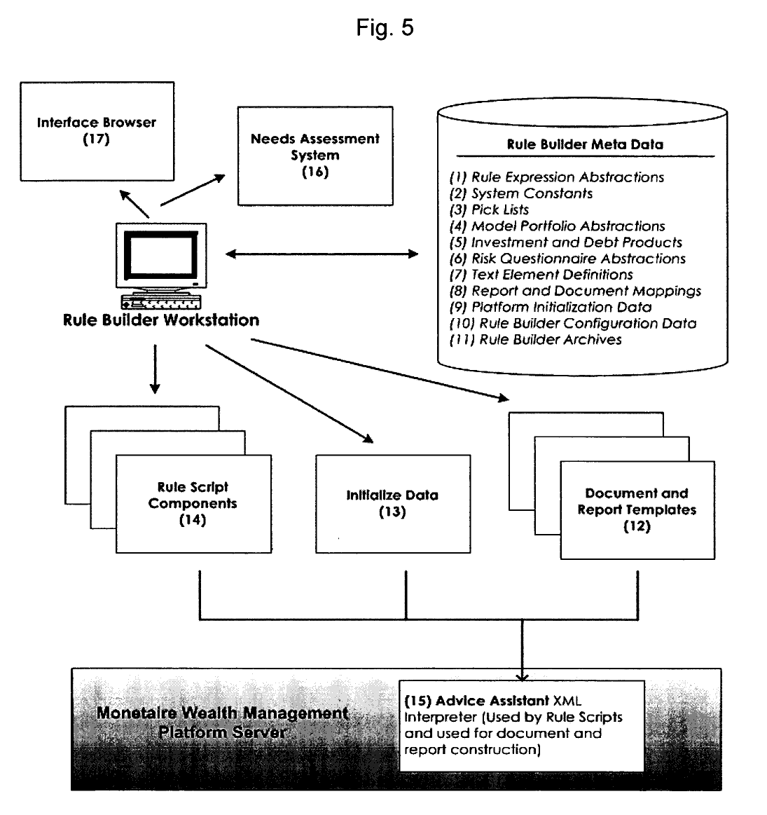

The Workstation, detailed in FIG. 5, also captures all system defined constants, pick-list elements, display elements and document templates. Once appropriate rules and related elements are defined, the Rule Builder Workstation (1) generates a Rule Set (2) and Platform Initialization Parameters (7), which can be changed at any time through the Workstation. This capability lets the BUSINESS user of the invention bypass ad-hoc software customization and fully control the Platform generated by the invention. The Workstation (1) is best used by a small number of individuals with clearly defined subject matter (e.g. compliance, products, sales process) responsibilities who establish and maintain operating rules and constants for the platform. The Rule Builder Workstation can be thought of as a very powerful administrative console.

For example, an Investment Manager might use the Workstation to define a risk profiling process through which a customer scoring 50 or higher on a risk tolerance questionnaire (created with the rule builder) is classified as an “aggressive investor.” They could further specify that, in the absence of other goals, a basic “wealth building portfolio” allocation of 75% equities and 25% fixed income is appropriate for an “aggressive investor.” These definitions are delineated in simple statements of the following type.

If the Risk Profile Score is Greater Then or Equal to 50 THEN

The Investor is Aggressive

If an investor is Aggressive THEN

Recommend a 75% equity, 25% bond portfolio

The invention permits rules to call (execute) other rules facilitating creation of functional primitives that can be referenced in many contexts. When a functional primitive is modified, all rules referencing it are automatically updated increasing abstraction layers and operating efficiency. Once required rules have been defined the invention checks their consistency, produces a test bed for automated case testing and, once approved, generates and installs code implementing them in the target application where they govern Platform behavior. In this way the invention displaces the entire traditional software design, development, testing and implementation process with a business user-driven method.

The following table outlines key elements of the Rule Builder.

| Rule Builder | |
|---|---|
| Workstation | FIG. 1 - Item 7 and |
| Elements | FIG. 5 - Detailed Diagram |
| Rule | Rules are cast as “if, then, else” expressions with unlimited |
| Expression | number of “else, ifs”. Each ‘then’ or ‘else’ branch returns a |
| Abstractions | calculated value and may assign that calculated value to a |
| | property of a business object. Every rule has a defined data |
| Item 1 | type. The element types that a rule may use in its calcula- |
| | tions include: data elements (e.g. values entered by a |
| | website visitor), system constants (e.g. a mortgage rate), |
| | mathematical functions (e.g. SUM—summation), constant |
| | values (e.g. the number 1000), table calculations, and other |
| | rules. Rules can be selected and edited or created. English |
| | (pseudo-code) and technical representations of rules are |
| | always available as are facilities to test rules and their |
| | effect on production applications. |
| System | A central repository for all system constants, such as default |
| Constants | values, allowing updates to be made in a single location and |
| | then flow through to appropriate applications that use the |
| Item 2 | changed system constants. Rules call constants instead of |
| | hard coded values to simplify updates and to maintain a |
| | central repository of definitions. |
| Pick Lists | A central repository of lists that applications may call on in |
| | determining characteristics of a customer. For example, a |
| Item 3 | list of customer age categories used in determining when to |
| | suggest purchasing life insurance. These pick lists are |
| | maintained centrally rather than in all places they are used |
| | to simplify updates and control. |
| Model | A facility for building suggested portfolios that maps |
| Portfolio | individual assets into asset classes and then maps those |
| Abstractions | asset classes into asset types. Once the portfolios are |
| | formed, the platform considers expected rates of return for |
| Item 4 | all portfolio members and calculates an expected return for |
| | the portfolio. Suggested portfolio composition for all |
| | customers segmentations are created as are rules determin- |
| | ing which portfolios are suggested to customers based on |
| | risk tolerance, time horizon, and stated goals. |
| Investment | A database of all products and services an FSP could offer |
| and Debt | to customers at the conclusion of a financial advice session. |
| Products | Products and services are mapped to the types of advice |
| | they follow, e.g. a list of possible credit cards and varying |
| Item 5 | rates to offer customers depending on their stated needs and |
| | also their credit history. |
| Risk | A facility for creating and editing risk tolerance question- |
| Question- | naires used in determining customer risk profiles. Multiple |
| naire | question and answer formats are supported, as is the ability |
| Abstractions | to easily weight answers. HTML is created in the Rule |
| | Builder Workstation so once the questions are written and |
| Item 7 | weighted they can be sent directly to production applica- |
| | tions without first consulting an HTML designer. |
| Text | A ‘what you see is what you get’ (WYSIWYG) editor is |
| Element | used to make changes to text elements of the platform. |
| Definitions | Changes made by business users via this facility can be sent |
| | to production applications without intervention of coders, |
| Item 7 | designers or other technology staff. |
| Report and | Documents are created using “elements” such as text |
| Document | fragments, sentences, paragraphs, or graphics. Each element |
| Mappings | can be easily edited and new ones can be added. Rules |
| and | govern which elements are included and excluded from |
| Templates | each end user document. Documents can call rules, |
| | attributes, and system constants. Documents are created in |
| Item 8 and | rich text format allowing easy modification and |
| | transformation. |
| Item 12 | |
| Platform | The end products of platform initialization are configuration |
| Initialization | files containing all relevant information required by our |
| Data | invention. This includes constants, pick-lists, rules, etc. |
| Item 9 | |
| Item 13 | |
| Rule Builder | The rule builder itself can be configured to the standards of |
| Configura- | and organization. For example, options related to default |
| tion Data | languages, fonts, colors, etc. can be controlled through the |
| | Rule Builder configuration options. |
| Item 10 | |
| Rule Builder | All changes to rules, output documents, and the platform |
| Archiving | initialization XML are archived and may be viewed in the |
| | Rule Builder's archive viewer facility. |
| Item 11 | |
| Needs | The NAS is a rich implementation of the document genera- |
| Assessment | tion functionality that provides report book quality presenta- |
| System | tions covering suggested actions to be taken based on a |
| (NAS) | private bank level customer. |
| Item 16 | |
| Interface | Allows the user to see the affects changes made to the |
| Browser | system will have on production applications before actually |
| | sending the changes (via updated XML script files) to the |
| Item 17 | production system. |
| Rule Script | Generates and transfers, via XML, the actual changes to |
| Components | production systems. Once transfers are made, the next user |
| | of the production application that has been affected will be |
| Item 14 | using the changed features. Compliance sign-off is an |
| | integral and integrated part of this process. |

Rule Builder interfaces to the Wealth Management Platform are handled by a proprietary DLL, “The Advice Assistant” (Item 15 in FIG. 5), which links Rule Builder outputs: scripts, documents, report constructions, etc. to other investment components implemented in the platform.

The Computation Engine (Item 3 in FIG. 1) provides an object-oriented abstraction of the full range of financial calculations performed by the current implementation of the invention.

The Computation Engine processes multiple permutations of overlapping conditions and constraints, monetary inflow/outflow scenarios and multi-stage processes that change characteristics based on critical events.

The Engine also links and integrates multiple scenarios, goals and plans combining multiple tactical plans into a holistic strategic financial plan, fully accounting for goal-specific resource allocations and funding priorities thereby eliminating the overlapping asset use problem inherent implementations based on prior art.

The Engine also processes the interdependencies arising from linked plans of multiple related individuals. For example the goals and assets of a husband, wife and one or more children can be included in an analysis linking dramatically different monetary inflows, outflows goals and constraints.

The computation engine, which performs all advice module calculations, can be accessed as a stand alone software component permitting, for example, other applications to solve complex investment advisory problems far exceeding the capacity of the calling program.

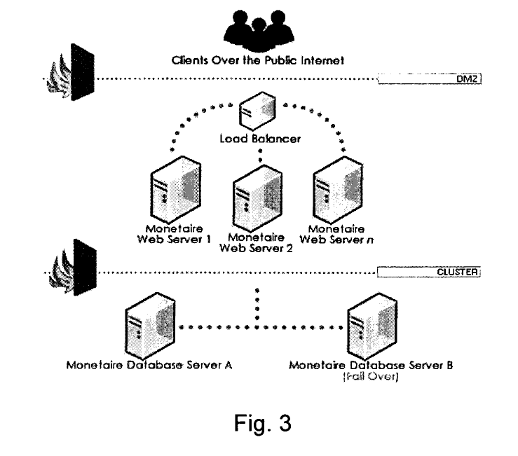

As shown in FIG. 3, item 20, the Computational Engine is also implemented using a ‘Web Service’ model allowing access from any computing environment supporting XML and HTTP.

Since the Engine encompasses both sides of the balance sheet, it handles liability planning and debt management problems in which the goal is to minimize risk-adjusted interest. For example, it provides comprehensive debt planning properly applying and assessing regular and promotional interest rates, minimum payments, pre-payment penalties, and collateral requirements. Debt management analyses incorporate multi-dimensional optimization and produce detailed periodic payment plans with precise instructions.

The following table outlines key elements of the Computation Engine component.

| Computa- | |
|---|---|
| tional | |
| Engine | |
| Summary | FIG. 1 - Item 3 |
| Common | The computational engine is the common code base for all |
| Code | platform quantitative functions. This dramatically increases |
| Base | the software quality and our ability to efficiently make |
| | significant feature extensions to the base platform. |
| Object- | The computational engine provides an object-oriented |
| Oriented | abstraction of complex financial calculations, scalable for |
| Abstraction | an Internet audience (potential for millions of calculations |
| | per hour), and leveraged across all module implementations |
| | (Retirement, Major Purchase, etc.) and delivery channels |
| | (Internet, Call Center, Intranet, etc.). |
| Scenario | The computational engine handles complex monetary |
| Management | inflow/outflow scenarios, inflation (real rates of return) vs. |
| | nominal rates of return, varying rates of return and accrual |
| | periods for each flow, multi-stage flows that change |
| | characteristics based on life events, loans as a source of |
| | goal funding, full analysis of period by period balances |
| | broken down by type (principal, interest, contributions), |
| | consolidated views of financial information across a ‘wealth |
| | group’ as well as individual views, and all fundamental |
| | financial calculations. |

The computational engine is a significant extension of the following basic financial calculations:

| Function | Description |
|---|---|
| FV | Future Value. Returns a value specifying the future value of |
| | an annuity based on periodic, fixed payments and a fixed |
| | interest rate. |
| PV | Present Value. Returns a Double specifying the present value |
| | of an annuity based on periodic, fixed payments to be paid in |
| | the future and a fixed interest rate. |
| Rate | Interest Rate. Returns a value specifying the interest rate per |
| | period for an annuity. |
| Pint | Payment. Returns a value specifying the payment for an |
| | annuity based on periodic, fixed payments and a fixed interest |
| | rate. |
| NPer | Number of Periods. Returns a Double specifying the number |
| | of periods for an annuity based on periodic, fixed payments |
| | and a fixed interest rate. |

While these functions are in use across the financial industry and present in most financial calculators, the platforms on which they are implemented do not support the needs of the complex iterative financial scenario simulation addressed by the invention. For example, the Engine processes and relates unlimited parallel time series of the type required to represent the complex conditional inflows and outflows associated with goal setting, alternative strategy assessment, tactical option evaluation, product service selection and plan tracking over time. The Engine applies the logic effecting applicable assumptions priorities and recommendations, reconciles flows over time and determines resulting outcomes. This functionality is unique and unlike any prior financial advisory tool, spreadsheet software or financial calculator.

User Interface Templates (item 6) are also shown in FIG. 1. Invention users require dramatically different presentation formats reflecting their organization's unique branding standards. Efficient, cost-effective implementation is achieved by starting with the generic template containing all capabilities of the invention.

Once defined, the user interface is deployed as an Interface Implementation (item 5 in FIG. 1). Distinct interfaces are often implemented for different delivery channels. For example call center representatives and advisory personnel require very different functionality, display structures, navigation and content than “self-service” consumers accessing the implementation directly over the public Internet.

Additionally, individual users can be exposed to different logic flows, functions, content and/or presentation based on selection criteria specified through the Rule Builder. The invention supports such multiple instances of the platform running simultaneously on a single server. Rule Builder defined logic determines the instance to which a given user is exposed and dynamic logic can modify display sequences and content based on session inputs. E.g., answers to questions determine subsequent interactions.

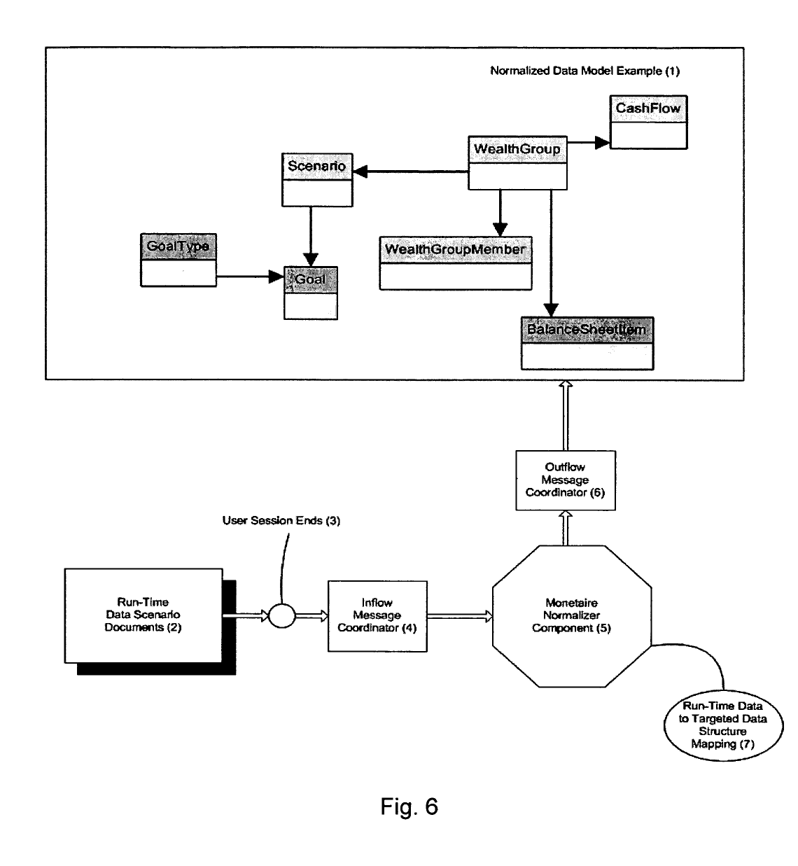

The Data Normalizer Component shown in FIG. 6 is the component of the invention which facilitates transforms platform data structures into a data construct that supports full management reporting, analytics and MIS. By implementing asynchronous data normalization this function can be performed without impacting invention performance or scalability.

The usefulness of the invention is in large part dependent on user ability to analyze the levels, trends, demographics and other attributes of activities that occur in the course of investment use. Such analyses must be available at any level of aggregation e.g., by individual, group, country, region market segment, etc. The Normalizer “bridges the gap” the invention's run-time data structure, which provides a high degree of scalability and flexibility, and the relational model required as input to analysis and reporting tools.

FIG. 6 is representative, rather than literal, presentation of the normalization process. The actual data model structure created by the invention is far more complex and may vary depending on unique user requirements. However this model segment illustrates key concepts of the invention including the Wealth Group, Wealth Group member, Balance Sheet Items, etc. These constructs form the core backbone of the invention's data structure in both the run-time and normalized data structures.

The user is given “read only” access to data in these structures, which can be modified only by the Normalizer. A user may, however access information from other systems to supplement and/or extend data stored by the invention. Thus invention processing is compatible with the common definition of a ‘data warehouse’ and in many cases the Normalizer Component will output to a pre-existing Data Warehouse.

The normalization process takes as input documents created or edited as the result of a single user's session with the platform. For example, if a new user is created on the platform and subsequently performs risk tolerance, retirement and major purchase analyses, a single data document containing all information captured is created. When the user's session is complete (item 3) the Normalizer begins the process of “normalizing” the resulting document into a relational (or equivalent) data structure.

Item 3, User Session Ends occurs when the user explicitly ‘logs out’—initiating a log out via the platform—or is ‘timed out’ due to inactivity. (The default idle time is a user configured parameter.)

Once a session has ended, the data document is transferred to the normalization process. Both asynchronous and synchronous transfer methods are supported but asynchronous message oriented middleware (MOM) infrastructure support is preferred to maintain solution scalability as noted above. This aspect of Normalizer related processing is shown in FIG. 6 item 4, Inflow Normalizer Message Coordinator. The Coordinator accepts data documents when a session ends and transfers them to the Normalizer Component, item 5, for processing.

To illustrate, when a user clicks the ‘logout’ button, a logout acknowledgement message is immediately displayed. Meanwhile, in the background, the invention initiates an asynchronous MOM message transferring the user's data document to the Inflow Message Coordinator, item 4. The message may be held in a storage queue until the Normalizer Component, item 5, is ready to process the data document. This design delivers instantaneous performance to the user while managing normalization processing in a scalable manner using first in first out (FIFO) queuing to ensure data integrity post-normalization.

In an asynchronous environment the Normalizer Component “listens” for waiting messages managed by the Inflow Message Coordinator, which it accepts and processes as resources allow. (In a synchronous environment the Inflow Message Coordinator serves only as a pass-through function.)

Once the Normalizer Component, Item 5, receives a data document from the Inflow Message Coordinator, item 4 it transforms document content for storage in a format that facilitates general analysis. This includes converting nodes, elements, attributes, hierarchies, etc. into corresponding data tables, columns and relationships. As noted, asynchronous processing decouples this function from the interactive aspect of the invention significantly increasing platform scalability.

The Normalizer Component creates and maintains a structural mapping of all data elements to targeted data storage tables, columns and relationships as represented by FIG. 6, item 7, the “Run-Time Data to Targeted Data Structure Mapping.” This map lets invention users customize the normalization process to meet, for example, the requirements of a pre-existing data warehouse. In this instance warehouse-specific table and column definitions are used in the normalization process.

The Normalizer Component also allows information to be added to the data stream for eventual storage. For example a user might wish to store the total sum of all equity based assets held by the individual originating a session. (The standard data document stores only total assets held across institutions.) The desired addition is effected by specifying logic via the Rule Builder Workstation to sum equities across institutions. Run-Time Data to Targeted Data Structure Mapping, item 7, then maps the resulting data into the targeted data repository.

Thus the Normalizer Component shown in item 5 transfers data received as input, transfers to the desired target data format while adding other ad-hoc data specified by the invention user.

Results of Normalizer Component, item 5, processing are sent to the Outflow Message Coordinator, item 6, which writes the results into the targeted data structure (or structures). This component provides an abstracted interface supporting multiple targeted data structures. Inclusion of new data repositories is effected by expanding the Outflow Message Coordinator. No change to the main Normalizer Component is required. This technique achieve a high degree of flexibility in extending the invention to support multiple data repositories and proprietary data formats required by an invention user.

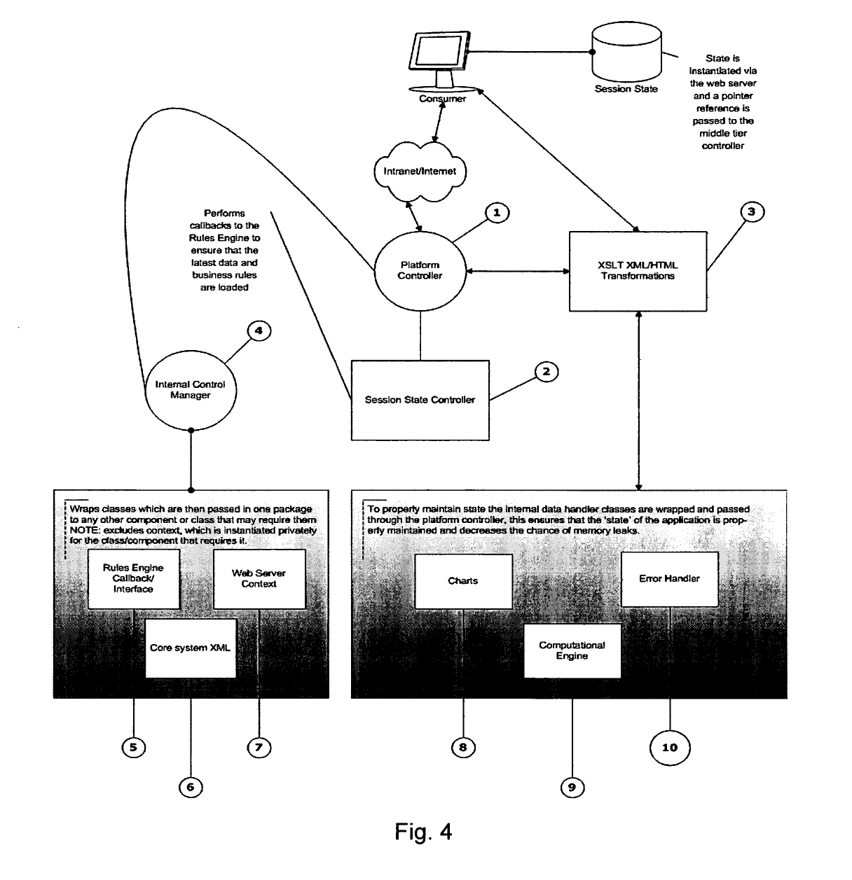

The Platform controller referenced in FIG. 1 item 4 and detailed in FIG. 4) coordinates all functions of the invention. It calls the Computation Engine, routes requests to the Rule Builder where appropriate and serves as the central switch for the application. This proxy software component provides the flexibility to extend and adapt the invention to any situation since all components are called only by the Platform Controller.

FIG. 4 item 1 details the primary entry points and software class publicly exposed to data consumers within the invention. All requests for data transformations are performed exclusively by this class. When initially called the Controller encapsulates and initializes the Internal Control Manger outlined below. After the internal manger is created this object passes back a reference to the requested object (and/or data transformation results) to the original caller.

Each call to the Controller initializes the session state controller object as shown in FIG. 4 item 2. This ensures that all current data are loaded into cached memory by comparing the latest version of business rules, data and static charts currently cached on the site to previously cached version numbers. If versions are out of sync, the object reloads all dynamic content, including static graphics the Rule Builder marks for regeneration. This allows frequently used information to be cached in primary server memory, providing unusually fast performance.

A primary purposes of the Platform Controller is to transform raw XML data into readable web pages or combine XML from various documents into one individual document as shown in FIG. 4 (3). To accomplish this, the controller applies style sheets to cached XML data using XSLT (Extensible Style sheet Language Transformations). XSLT specifies industry standard (non-proprietary) language definitions for XML data presentation and transformation. This object allows the invention to support multiple computing platforms and systems as well as a common abstract data transfer layer utilized by both the data consumer and Platform controller (FIG. 4).

FIG. 4 item 4 describes the class which is used to reduce the number of internal call requests and processor/memory overhead for common objects or those that need to be marshaled across processor threads. For this class all primary and/or extensively used classes are wrapped within the control manager. Included classes are the callback objects for the Rule Builder, the core controller XML and the session state passed in the data consumer.

Once all necessary objects have been packaged into the manager, subsequent requests within the component reference this package, instead of making individual calls. This object ensures that all transaction requests made to the Controller are properly terminated and/or rolled back and flushed from memory to preclude processor memory leaks. This technique maximizes performance as well as flexibility.

The callback interface, FIG. 4 item 5, allows the platform controller to provide and/or cache dynamic content and business rule sets generated by the Rule Builder. For example, if the data consumer requests the portfolio recommended for a particular account based on the account's risk profile assessment, the recommended portfolio for a given score is dynamically determined by Rule Builder produced rule sets. This software class passes a reference of itself to the Rule Builder, which can be running on a separate server, along with core XML data. Rule Sets thus have access to specific methods and properties in the controller allowing them to determine the weighted profile score and return appropriate recommendations.

To give the Platform Controller cross platform/operating system compatibility, along with increased scalability, the controller uses XML documents to cache and provide data to the data consumer as shown in FIG. 4 item 6. XML provides a uniform method for describing and exchanging structured data that is independent of applications or vendors.

All images shown in FIG. 4 item 8 are generated from the data contained in the Internal Control Manager (FIG. 4, item 4). The chart class can be used by the controller directly, to assemble graphic displays based on predefined data or it can be instantiated by an external process outside the controller's scope. The software class itself also uses XML as its primary data transport method for both requesting and sending graphics.

The Platform maintains a high level of security with respect to all referenced data by limiting the methods used to read and write data from the application server to the data consumer. The preferred method for wrapping and maintaining a particular instance of a web session and its properties is to wrap the web server context, which is then exposed for processing to the rest of the middle tier. This software class is never passed between classes within the controller. Instead, it is instantiated and destroyed by any class that may need to access its properties and/or methods.

Each method and property within the Platform Controller includes a call to the error handler, FIG. 4 Item 10. This object ensures that run-time errors are managed in a consistent manner regardless of the object creating an exception.

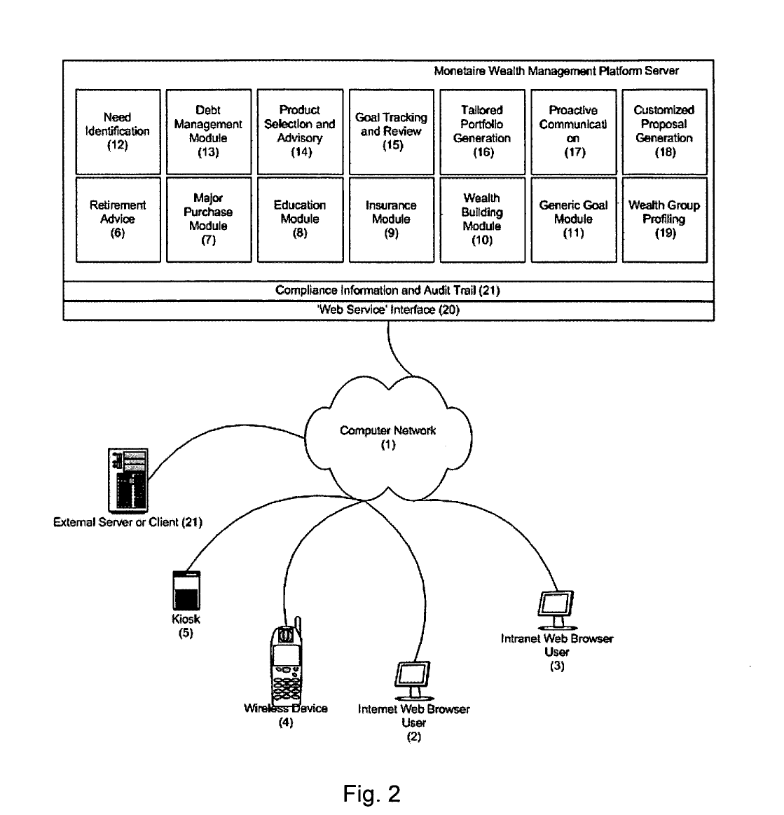

As shown in FIG. 2 a computer network (item 1) typically based on TCP/IP and supporting HTTP/S protocols for target users is normally, but not always, required to deliver the invention's functionality. FIG. 2 depicts this as an Internet Web Browser User (item 2) and an Intranet Web Browser User (item 3). Users run a ‘web browser’ and navigate to a URL providing access to a platform incorporating the invention.

The invention supports alternative devises in addition to web delivery. In FIG. 2 these are represented by wireless devices (item 4) and fixed Kiosks (item 5). Interface for these devices can be customized to maximize user experience via the channel.

FIG. 2 also show an External Server or Client (item 21) accessing the platform using a Web Services Interface (item 20). The Web Services Interface lets External Servers or Clients make Simple Object Access Protocol (SOAP) message calls conforming to World Wide Web Consortium standards. This access method typically uses XML over HTTP/S in which case the platform returns XML to the calling External Server or Client.

The invention can be described in terms of the high level features /functionality of platforms in which it is imbedded.

The Platform helps financial services customers identify and prioritize major life events and other tactical financial needs. This capability is represented in FIG. 2 by item 12 Need Identification. Needs may be tactical, involving a single goal such as retirement, or strategic, encompassing a range of events and conditions which, in combination, constitute a lifetime plan.

The invention enables customers or their advisors define goals associated with priority needs, formulate funding plans, and evaluate alternative programs to achieve their objectives. Goals can be considered separately or, in combination as part of an integrated strategic lifetime financial plan. Affluent investors are guided through flexible descriptions of their current financial situation and alternative future scenarios letting them evaluate options and develop plans at the level of detail appropriate to their needs. Probable balance sheet, income statement and cash flow implications of alternative scenarios match the granularity of customer inputs.

FIG. 2 notes representative advice modules including:

Item 6—Retirement

Item 7—Major Purchase

Item 8—Education

Item 9—Insurance

Item 10—Wealth Building

Item 13—Debt Management

These examples represent specific implementations of a Generic Goal Module (item 11), a template for implementing new advice modules involving previously undefined goals using the invention's unique abstraction of financial parameters discussed in Section G.1 below. The Generic Goal Module speeds invention extension to cover new concepts by eliminating the need for ad-hoc software programming.

Advice generation starts with goal assessment in light of the customer/prospect's current investment and credit programs available to fund the goal. The invention evaluates the level and sources of historical and projected future returns and volatility associated with applied asset allocations and leverage. Tailored assessments of current investment and credit programs may be produced through rule-driven consultative dialogues highlighting strengths and weaknesses of current approaches.

The platform suggests alternative asset allocations designed to maximize the probability of achieving defined goals within specified constraints. As shown in FIG. 2, Tailored Portfolio Generation (item 16) modules produce optimized investment and loan portfolios tailored to customer risk tolerance, needs, preferences knowledge, sophistication and involvement. Recommendations are generated using Rule Sets incorporating the best judgments of the FSP's own, or selected external, financial professionals.

If a suggested allocation is adopted the invention rebalances the current portfolio to match the recommended structure. To avoid double counting of assets, rebalancing considers allocations to all currently funded customer goals.

Resulting solutions are implemented through human or Rule Set driven virtual agents using customer-preferred forms of advice and execution. The system then maintains and references these portfolios in subsequent proposals, compliance oversight, service delivery tracking and customer reviews

After establishing customer-preferred asset and or liability portfolios from the advice modules, the platform suggests specific products and services meeting customer selection criteria linking the sale of appropriate offerings to the satisfaction of customer needs. This is shown in FIG. 2 item 14, Product Selection and Advisory.

Supported product offerings can include banking services (checking accounts, savings accounts, etc.), investments (stocks, bonds, annuities, mutual funds, custody accounts, etc.), credit products (credit cards, mortgages, home equity lines, etc.), and insurance products (life, health, property/casualty, etc.).

The invention enables FSPs to objectively implement all actionable elements of system-generated proposals using appropriate and suitable proprietary and/or third party offerings. Product selection can be based on client criteria, customer preference rankings or external product evaluation services such as Morningstar. Customers can purchase selected products through the FSP's transaction processors or external transaction processors accessed through Platform interfaces.

FIG. 2 Item 19 references Wealth Groups defined as one or more individuals that form a unit with a shared financial goal. For example a husband and wife formulating a joint retirement plan. Basic demographics such as date of birth and annual income are captured for Wealth Group Members.

The invention establishes composite Wealth Group Risk Tolerance Assessments following approved protocols and associated questionnaires and scoring procedures defined, and easily modified, in the Rule Builder.

The invention implements a structured and globally consistent customer profiling and investment objective setting process that captures and maintains data required to comply with noted regulatory compliance requirements. To avoid negative response, the process is non-invasive, focusing on customer circumstances, needs and preferences in ways that demonstrate concern for customer needs, a desire to meet customer objectives and commitment to the highest standards of professional conduct.

As shown in FIG. 2, item 21, a complete audit trail containing information required for compliance oversight gathered through this process is maintained for all platform-based interactions. This contemporaneous record of date- and context-specific “Know Your Customer”, anti-money laundering, investment and credit risk tolerances is an invaluable reference in the event of disputes over advice delivered or customer inputs on which it was based.

As shown in FIG. 2 item 18, Customized Proposal Generation produces goal specific investment and credit programs tailored to customer needs, constraints and preferences using templates as defined in the Rule Builder. This capability significantly enhances advisor productivity by leveraging standard templates and rule sets reflecting their organization's best practices.

Rule driven technology generates regulatory compliant analyses and recommendations using up to date market data and the best judgment of FSP and/or external experts. Resulting communications, delivered through human or virtual advisors, contain comprehensive strategic and tactical advice as well as product/service recommendations tailored to customer or prospect goals, needs and preferences in languages and formats they select. These assessments and proposals dramatically demonstrate that the FSP is “listening” to customer concerns and responding directly to their priorities, ambitions and fears by creating customized offerings meeting their individual requirements.

The Proactive Communication module referenced by FIG. 2 item 17 generate product/service- and market-based letters, e-mails and presentations tailored sales/product management priorities and customer situations, goals and preferences. This function of the invention identifies customers who might benefit from, or be adversely affected by, new or modified product offerings, regulatory or tax law changes; economic, market, industry or company developments and life cycle or wealth level changes. It then produces customer-specific communications describing these developments, their relevance to the customer and action alternatives.

Rule Sets applied to previously collected information detects actionable customer situations. Demographics developed through Customer Profiling describe age, life style, investment and credit conditions producing opportunities or problems. Goal, priority and preference data acquired through Profiling and Goal Setting identify customers for whom significant external economic, market or product developments are relevant. Plan implementation data tracked in the review process isolate those investing or borrowing in geographic areas, industry sectors, products and/or securities affected by observed changes.

Rule sets developed in the Rule Builder Workstation drive Custom Proposal Generation (FIG. 2 item 18) relating developments to individual customer situations and describing associated problems or opportunities. These communications discussing the situation, its relevance for the customer and appropriate remedial action are automatically routed to human advisors or sent directly to customers via letter, e-mail or phone message.

Once advisory plans have been executed, the platform monitors progress through goal tracking and review (FIG. 2 item 15). Goal status and remedial recommendations can be communicated through E-mail, fax, phone or other channels. Printed reports and periodic advisor reviews tailored to customer requirements are also generated by the invention.

Rule set-driven interactions develop customer profiles, set objective and generate regulatory compliant recommendations tailored to customer goals, needs and preferences. Adding the ability to track actual performance against goals and compare realized and targeted results eliminates previously noted impediments and lets customers' plan and mange ongoing goal-oriented financial programs.

When implementing a plan, customers can specify notification criteria defining portfolio, asset class and/or individual holdings conditions under which alerts or remedial change recommendations are to be generated through selected channels. Customer customized portal modules may also incorporate a “Goals Forecast” section that informs the customer of progress against the goals they have established. Other modules, which we urge client management to include, provide automated annual goal achievement reviews.

The following table highlights features and functions of the invention listing the business and customer support functions discussed above.

| Invention | |
|---|---|
| Major | |
| Features | Description |
| Channels | Application interfaces appropriate for relationship managers, |
| and | call center personnel, and end-use FSP customers, delivered |
| Wealth | via web-browsers across company intranets, extranets, or the |
| Segments | Internet, are all supported by the platform. Any wealth |
| | segmentation an FSP uses, from retail to private bank, is sup- |
| | ported via business rules. The delivery of financial advice |
| | uniformly across multiple distribution channels ensures con- |
| | sistency of communication and customer experience. The |
| | customer experience is completely customizable and can be |
| | used in extending existing websites and applications or in |
| | building new ones. FSP brand standards are supported without |
| | difficulty. |
| Wealth | The platform's underlying data model handles all data |
| Group | necessary to deliver robust financial advice. This includes |
| Profiling | personal, demographic, financial, and risk profile information |
| | for individuals as well as wealth groups. Previously estab- |
| | lished goals are also stored in customer profiles along with |
| | planning conditions and assumptions, including: family |
| | member information, economic expectations, client-supplied |
| | assumptions, income sources, wealth transfer plans, living |
| | expenses, investments, and balance sheet data |
| Advice | The platform encompasses planning for life events and other |
| Modules | financial needs through a series of financial advice modules. |
| | Clients select from modules provided with the platform or |
| | create their own using business rules and financial relationship |
| | descriptions embedded in the platform. Modules covering |
| | balance sheet, income statement, and cash flow issues over |
| | relevant planning time horizons and are tightly linked to |
| | assure every goal is considered in the context of the cus- |
| | tomer's overall financial situation and assets are not double |
| | counted or used to achieve more than one goal. Life events |
| | supported by the platform include: education, marriage, home |
| | purchase, childbirth, elder care, divorce, retirement, wealth |
| | transfer, and death. Other financial needs supported include: |
| | managing credit, managing living expenses, building and |
| | preserving wealth, minimizing taxes, funding major pur- |
| | chases, and planning for life changes. |
| Financial | Customers can set goals using self-service websites or with |
| Goals | the assistance of a relationship manager for any or all of the |
| | modules. The platform also allows individuals to set multiple |
| | goals within a module. For example, within the funding major |
| | purchase module, a customer could set a goal to purchase a |
| | new car and a new boat over different time horizons. The |
| | process begins with choosing a goal, investigating resources |
| | available to fund the goal, performing a gap analysis, and |
| | assessing current portfolio asset allocation and risk/return |
| | profile |
| Asset | Once goals are set, the platform suggests an asset allocation |
| Allocation | and portfolio rebalancing to achieve the goal(s). Portfolio |
| | rebalancing is done with respect to time horizon, risk profile, |
| | and all customer goals to avoid double counting of assets. A |
| | recommended course of action is suggested and alternatives |
| | are presented. A Capital Assets Model allocation engine |
| | embedded in the platform that FSPs may choose to employ. |
| | The platform also can use the existing FSP asset allocation |
| | methodology. |
| Product | After establishing single or multiple goals and appropriate |
| Selection | portfolio rebalancing, the platform suggests specific products |
| and | and services to implement plans. The platform is capable of |
| Advisory | handling both FSP proprietary and third party product offer- |
| | ings. Product and service recommendations can be based on |
| | FSP unique business rules, customer inputs, or data provided |
| | by third party suppliers such as mutual fund ranking com- |
| | panies. Products the platform can suggest include: banking |
| | services such as checking and savings accounts, investments |
| | such as annuities, bonds, stocks, mutual funds, managed |
| | portfolios, trusts, and custody accounts, credit products such |
| | as credit cards, auto loans, collateralized loans, home equity |
| | lines, and mortgages, and insurance products such as continu- |
| | ing care, life, health, disability, and property/casualty. |
| Goal | Once plans have been executed by purchasing suggested |
| Tracking | products or services, the platform's goal tracking capabilities |
| and | monitor progress towards achievement over time. Progress can |
| Review | be reported online giving customers instant access and in for- |
| | matted, hard-copy report books relationship managers period- |
| | ically review with customers. |

The invention is based on the concept that all financial transactions, however seemingly complex, can be decomposed into two types of elements: A limited set of financial “objects” e.g. asset classes, with one or more defining attributes e.g. historical returns. And one or more series of transactions e.g. payments

The structure and implications of this concept are described under four headings: Abstracted Objects; Abstracted Transaction Series, Abstracted Template Structure, Implementation of the Structure

The abstraction condenses the elements of financial goals and funding plans to six objects including: investments made up of products, within goal-specific portfolios, and classified by Asset Class; desired types and amounts of payments are single lump sum payments; multiple periodic payments and residual amounts to remain after all payments have been made.

Goal-specific funding plans consisting of current investments to be applied to goal; future lump sum investments to be made at start or end of specified periods; future savings to be contributed at start or end of various time periods; expected future funding from property sale, etc. at start/end of periods; mortgages and home equity loans; providing funds at a point in time; bearing an interest rate; to be paid off over a specified time period; and other Loans with characteristics similar to those of mortgages

Balances at start of payout required to achieve payout goal for lump sum payments; periodic payments and residual remaining after final payment.

Balances from current funding plan at start of payout from current investments; future lump sum investments; planned future savings; future property sales, etc.; mortgage and home equity loans proceeds and balance at start of payout; repayment balances pre-loan repayment and at start of payout; and other Loans as for Mortgages.

Comparative balances at start of payout including total balance required to meet goal; combined balances produced by plan; and excess or short fall—(Plan minus Goal).

Financial computations are abstracted into four decomposed transaction series including expected asset growth over time until payments begin for current investments; future lump sum investments; planned future savings; and funds from sale of property, etc.

Expected effect of debt finding plans including mortgage and home equity loans; proceeds from loan; repayment costs; and other debt instruments.

Payment type includes single lump sum payments; multiple periodic payments; residual amounts remaining at end of payout period; total payments of all types.

Payout and Residual Amounts Produced by Plan including IF Goal Level Payout Periods are Maintained; single lump sum payments; multiple periodic payments; residual amounts remaining at end of payout period; total payments of all types; IF Goal Level Payment Amounts are Maintained as above

Goal and Funding Plan Definition Inputs including recommended Asset Allocations—Simplified Example; allocation of Investments during Goal Funding Period; allocation to Cash; average annual return on Cash holdings (%); allocation to Bonds; average annual return on Bond holdings (%); allocation to Equities; average annual return on Equity holdings (%); allocation to Real Estate; average annual return on Equity holdings (%); combined Allocation to All Investment Asset Classes; resulting annualized rate of return on Investments; allocation of Saving Contributions during Goal Funding Period Allocation to Cash, Bonds, Equities and Real Estate for Savings; combined Allocation to All Saving Asset Classes; resulting annualized rate of return on Savings; allocation of Funds applied to Goal during Goal Payout Period; allocation to Cash, Bonds, Equities and Real Estate in Payout Period Combined Allocation to Asset Classes during Payout Period; resulting annualized rate of return on Assets during Payout Period; rates of Return applied to calculations During Goal Funding Period Real Rate of Return on Investments (%/period); real Rate of Return on Savings (%/period) Rates on Return on Funds Remaining During Payout Period; real Rate of Return on Remaining Funds (%/period).

Goal Definition Inputs—goal objective is to receive the following payments: Lump Sum Payments

Single Payments of specified amounts at start/end of specific period; Periodic Payments; Multiple Payments of specified amounts at start/end of time periods; Residual; Amount to remain after lump sum and periodic payments are made.

Funding Plan Definition Inputs—Plans to fund goal with assets from: Current Investments; Current Assets applied to Goal Funding; Future Lump Sum Investments to Goal; Lump sum investments for goal at start/end of specified period; Future Saving for Goal; Savings at start or end of a range of time periods applied to goal; Expected Future Funding from property Sale, etc.; Future cash inflows at start/end of specified periods applied to goal; Mortgages and Home Equity Loan Funding; Amounts obtained from Mortgages or Home Equity Loans for goal; With Proceeds received in defined period

At specific periodic interest cost; Mortgage paid off over specified period; and other Loans

Amounts obtained from Mortgages or Home Equity Loans for goal with proceeds received in defined period; at specific periodic interest cost; loan paid off over specified period

Expected Growth of Investments during Funding Period: Computations use previously entered Investment/Savings Returns; Expected Growth of Current Investments; Growth of Current Investments until start of payout; Expected Growth of Future Lump Sum Investments; Growth of Lump Sum Investments during/after investment period; Expected Growth of Planned Future savings; Growth of Savings during and after saving period; Expected Growth of Funds from Property Sale, etc.; Growth of Cash from property sale, during/after investment period.

Expected Effect of Mortgages and Other Loans: Expected Effect of Mortgage and Home Equity Loans

Proceeds and repayment costs of Mortgage/Home Equity Loan; Expected Effect of Other Loans

Proceeds from, and repayment costs of, other loans applied to goal.

Funds Required at Start of Payout Period to Achieve Payout Goals: Rates of Return to be applied during Funding and Payout; Real Rate calculated from Recommended Asset Allocations; Goal Payout Components (From Inputs above); Lump Sum Payments; Balance Required: At End of Plan Funding Period; Balance Required At Start of Lump Sum Payment; Periodic Payments; Balance Required: At End of Plan Funding Period; Balance Required At Start of Periodic Payments; Residual Remaining after final Payment; Balance Required: At End of Plan Funding Period; Balance Required At End of Payout=Start of Residual Period; Total Payments Made at Goal Amounts and Time Periods

Funding Requirements and Plan Performance Computations including: Balance at Start of Payout Period produced by Current Plan; Balance Resulting from Current Investments; Balance Available At End of Funding with Current Assets; Balance Available from Current Assets at Start of Payout Period

Balance Resulting from Future Lump Sum Investments; Balance Available At End of Funding with Future Lump Sum Assets; Balance from Future Lump Sum Assets at Start of Payout Period

Balance Resulting from Planned Future savings; Balance Available At End of Funding with Future Savings; Balance from Future Savings at Start of Payout Period; Balance Resulting from Future Property Sale, etc.; Balance Available At End of Future Property Sale Funding; Balance from Future Property Sales at Start of Payout; Balance Provided by Mortgage and Home Equity Loans; Balance of Proceeds from Mortgage or Home Equity Loan: At end of funding; At Start of Payout; Mortgage or Home Loan Repayment Balance Required: At Start of Loan Pay Back; At Start of Goal Plan Pay out

Balance Provided by Other Loans; Balance of Proceeds from Other Loans as for mortgages

Other Loan Repayment Balance Required as for mortgages; Combined Net Balances From Plan

Summary Goal versus Plan Gap Analysis Illustration: Investment Balances at Start of Payout

Required to meet Goals; Produced by Plan; Difference—Excess or (Short Fall): Amount

Plan to Goal Balances Ratio; Goal Level Payout Plus Residual Amounts; Lump Sum Payments

Periodic Payments; Residual Remaining after final Payment; Total Payments at Goal Levels

Payout Plus Residual Amounts Under Current Plan; Payments IF Goal Level Payout Periods are Maintained; Lump Sum Payments; Periodic Payments; Residual Remaining after final Payment

Total payments made if payout period is maintained; Payout IF Goal Level Payment Amounts are Maintained; Lump Sum Payments; Periodic Payments; Residual Remaining after final Payment

Total payments period if payout amounts are maintained.

### Implementation of the Structure

The structure previously illustrated provides a simplified illustration of the use of the abstracted objects and transaction series in financial goal setting, analysis, funding and tracking to represent any type of financial situation and related analysis/recommendation. It further demonstrates how the use of pre-defined components eliminates the need for ad-hoc definition and coding.

The Rule Builder WorkStation permits Subject Matter Experts rather than programmers to define unrestricted combinations of business or processing rules and logic. It facilitates rapid design and adaptation of criteria controlling Application process flow, advice delivery, content presentation sequence and GUI/Report content and format without coding.

Once tested in a Rule Builder copy of the application, and approved by designated investment and compliance persons, the Rule Builder translates the business logic into fully functioning XML operations converting subject matter expert specifications into fully function code without system developer or programmer involvement.

The present invention uses abstracted software classes and decomposed transaction series in financial goal setting, analysis, funding and tracking. It incorporates the eight-step process outlined below, which eliminates in most cases the need for ad-hoc definition and coding when customizations are required.

Define Applicable Asset Allocations—Simplified Example.

Allocation of investments during Goal Funding Period

Specify allocation to Cash, Bonds, Equities and Real Estate

Record average annual return estimates to be used for each asset class

System checks that combined allocation totals 100%

Enter allocation of saving contributions during funding Period as above

Enter allocation of funds during goal payout period as above

System computes rates of return to be applied during funding Period

Real Rate of Return on Investments (%/period)

Real Rate of Return on Savings (%/period)

The Template computes return rates applied during Goal Payout Period

Real Rate of Return on Remaining Funds (%/period)

Define Goal Objectives: Types and amounts of payments you want to receive

Lump Sum Payments

Single Payments of specified amounts at start/end of defined period

Periodic Payments

Multiple Payments of defined amounts at start/end of time periods

Residual

Amount to remain after all lump sum/periodic payments are made

Define Funding Plan: Your plans to fund goal using assets from:

Current Investments

Current Assets you are using to find this goal

Future Lump Sum Investments

Single amounts to invest in goal at start/end of specified periods

Future Saving

Periodic savings to contribute to goal at start/end of time periods

Expected Future Funding from property Sale, etc.

Future cash inflows at start/end of specified periods to fund the goal

Mortgages and Home Equity Loan Funding

Amounts from Mortgages or Home Equity Loans to fund the goal

When you expect to receive the funds

The interest rate you anticipate paying

The time period over which the mortgage or loan paid off

System calculates periodic payments required to implement plan

Other Loans

Amounts you'll obtain from other loans to fund the goal

Detail as for Mortgages above

System calculates periodic payments required to implement plan

Platform Illustrates the Investment Growth and Debt Costs of entered Plan

Expected Growth of Investments during Funding Period

Investment/savings return rates based on entered asset allocations

Growth of Current Investments until start of payout

Growth of Future Lump Sum Investments until start of payout

Growth of Planned Future savings until date payments begin

Growth of Funds from Property Sale, until the date payments begin

Expected Effect of Mortgages and Other Loans

Expected Effect of Mortgage and Home Equity Loans

Proceeds and repayment costs of Mortgage or Home Equity Loan

Expected Effect of Other Loans

Proceeds and repayment costs of other loans applied to goal funding

Platform computes Funding Requirements and Plan Performance

Funds Required at Start of Payout Period to Achieve Payout Goals

Funding requirements are computed for each goal objective entered

Lump Sum Payments

Balances required to fund lump sum payments:

At end of funding period

At start of lump sum payments

Periodic Payments

Balances required to fund periodic payments:

At end of funding period

At start of lump sum payments

Residual Remaining after final Payment

Balances required to fund residual creation:

At end of funding period

At end all payments

Platform calculates total balance required to fully fund all goals

Funding Requirements and Plan Performance Computations

Platform Calculates Start of Payout Period Balances from Funding Plan

Balance Resulting from Current Investments

Current asset balance today and at start of payout period

Balance Resulting from Future Lump Sum Investments

Balance available at end of future funding and start of payout period

Balance Resulting from Planned Future savings

Balance available at end of planned future saving and start of payout

Balance Resulting from Future Property Sale, etc.

Balance available at end of future property sale and start of payout

Balance Provided by Mortgage and Home Equity Loans

Balances from proceeds of mortgage or home equity loan:

At end of funding period

At start of lump sum payments

Balances required to fund mortgage or home equity loan repayment:

At start of payout period

At start of loan payback

Balance Provided by Other Loans

Balances from proceeds as for mortgages and home equity loans

Balances required to fund loan repayment as for mortgages,.

Combined Net Balances From Plan

Combined balances from all sources available at start of payout

Platform Summarizes Goal versus Plan Results in Gap Analysis

Comparative Balances at Start of Payout

Balances:

Required to meet goal

Produced by plan

Resulting excess or short fall

Plan to Goal Balances

Goal Level Payout Plus Residual Amounts

Goal level lump sum, periodic, residual and total

Payout Plus Residual Amounts Under Current Plan

Payments IF Goal Level Payout Periods are maintained

Lump sum payments permitted by goal payout period

Periodic payments possible with goal payout period

Residual payment available ate end of goal payout periods

Total plan payments possible with goal payout periods

Payout Periods IF Goal Level Payment Amounts are Maintained

Number of lump sum payments of goal amount

Periodic payment times possible with goal payout period

Time when goal level residual payment can be made

Total payout period duration with goal payout amounts

Total Plan Payments possible with Payout Amounts Maintained

The technical architecture of the platform on which the invention is implemented is unique in providing a large degree of scalability (the capacity to handle many users) with extensive flexibility. Traditionally companies have had to make trade-off decisions between flexibility and scalability. The invention effectively mitigates this problem.

The platform is best deployed on at least two physical application servers and one or more relational database server. The use of two or more application servers permits the invention user to leverage its ability to achieve “fault tolerant processing” by running across multiple computers. (The use of a hardware clusters for the invention-based platform's database environment provides additional fault tolerance.)

When using the invention to supports user access over the public Internet we recommend the use of “firewall” technology to secure the environment from hackers. A common term used to describe this deployment architecture is a Demilitarized Zone (DMZ) where a firewall is deployed both in front of, and behind, the server computers, which are the entry point to the organizations private network. This deployment architecture requires a hacker to pass through two separate firewall barriers to access the company's private network. (FIG. 3 illustrates such a deployment strategy.)

Invention deployment security is further improved by limiting open TCP/IP ports. The top firewall may only allow ports 80 and 443 to remain open. These are the HTTP and HTTPS ports respectively. The second firewall may only allow a single port to be open (say 1433) which is then used by the primary servers to communicate with the platform database environment, which resides on the company's private network. This deployment model is shown in FIG. 3.

When an investment user wishes to support both Internet and Intranet environments using one physically architecture, we recommend the first approach described in this section. Internal users access the invention through the single open port (1433 in this example), which is specified in the URL through which the application is accessed. For example, if the invention is exposed to public internet users via the URL: www.monetaireadvice.com, the web server would be configured to expose the platform on port 1433 in addition to ports 80 and 443. An internal user such as a banker or branch manager would use the following URL: www.monetaireadvice.com:1433. (The colon denotes port specification.)

Key concepts and technologies used to create the invention include an Object-Oriented Software Design Patterns. The use of design patterns applies the organization's ‘tried and true’ knowledge to existing design problems, eliminates “reinventing the wheel” and significantly improves the quality of software while reducing completion time and cost.

For example a common design pattern is the ‘Bridge’ construct used to decouple an abstraction from its implementation so that the two can vary independently. The invention was created using bridge patterns for all database access. This permits the database to be easily modified without changing underlying abstractions.

Using the bridge pattern will decouples interface and implementation; improves extensibility; and hides implementation details from clients

Use of the Unified Modeling Language insured that developers working on investment-related software shared a common visual language during investment design and implementation. This approach, founded on the belief that built “a picture is worth a thousand words” enhances software design quality by providing a shared understanding and efficient means of communicating complex software design issues and solutions.

UML-based design dramatically increase developer productivity and software quality by focusing discussions on visual diagrams that efficiently represent even the most complex software engineering issues.

Invention implementation was managed by fully defining attributes the invention must posses to meet the requirements of anticipated users. This involved a rigorous management process incorporating artifacts such as visual prototypes, spreadsheets, models, detailed requirements documents and Use Cases to define requirements and implement the invention.

This section describes preferred implementation techniques and methods used to create the invention. These techniques and methods are equally applicable across all aspects of the invention (Rule Builder, Computational Engine, Platform Controller and Overall Architecture).

Internet technologies often lack a standard approach to user specific data management—user navigation through application elements. This is referred to as “session state.” The invention manages session states in a way that allows users to execute its code across a series of distributed computers.

This is done by creating an object-oriented component that manages all session-state information leveraging the common data store that is shared among server computers. This uses a common API for retrieving and setting user information, regardless of the physical machine on which the user is currently executing code.

The invention is not tied to any specific database. The object-oriented abstracted interface it contains easily supports any database environment. This result could only be achieved through an implementation process that built on and leveraged extensive software abstractions as discussed above.

The invention implements a unique data management and storage capability based on maintaining all real-time session information using XML stored in a central data repository and loaded on demand. The XML is also passed to the Rule Builder generated Rule sets as necessary under control of the Platform Controller (FIG. 4).

Once a session has ended the Normalizer described in Section V.D transforms the XML into a database structure appropriate for On-Line Analytical Processing (OLAP) and MIS information reporting. This unique technique allows the invention to process thousands of users while fully supporting all required management reporting and analysis.

Quality software development requires revalidation of previously working functionality as new capabilities are added to an implementation. Implementation of the invention leveraged automated regression tools which fully retest and verify full application functionality as each change is implemented.

This automated regression testing is a compliment to standard manual testing performed at both the unit and system level throughout invention implementation.

Unicode character encoding standards were used to meet design requirements that the invention support all major global languages including written formats such as Kanji, Hiragana and Arabic). Use of Unicode permits the invention to be used with multiple platforms, languages and countries without re-engineering or software redevelopment and permits invention-resident data to be transported across many system boundaries without corruption.

Due to the complexity of the invention software code source control tools were used throughout development to establish version controls, facilitate reversion to previous versions if necessary and simplifying code version comparisons.

Daily build processing was used throughout invention development. This required each developer to ‘checks in’ his or her code at the end of each day. A new software ‘build,’ which was a fully functional version of the invention was then created (with incomplete features ‘stubbed’ out).

This significantly reduces incompatible integration problems created by waiting until late in the development process to integrate individual code units constructed by diverse developers.

While assessing options for implementing the invention we considered many technical alternatives including those presented below.

We performed a comprehensive analysis of the existing Expert System technologies available in the market. All failed our ease of use requirement specifying that the invention must permit business professionals without software development or programming skills to define and modify invention-based platforms. Existing alternatives required a level of expertise far exceeding design goals.

Although considered, the use of non object-oriented development methodologies was rejected due to the lack of flexibility and added complexity. The decision to use an object-oriented approach increased the initial complexity of development but significantly enhanced the ultimate flexibility of the invention and permitted faster extension and modification.

Object-oriented development also allowed us to full take advantage of two previously discussed critical enabling concepts: Design Patterns and UML.

Creating the invention as a traditional Client/Server desktop application offered several advantages. The most compelling is that eliminating the web browser permits much of the processing complexity to be moved to the desktop where the power of individual workstations can be leveraged. This advantage was, however outweighed by numerous disadvantages including: include high deployment costs; potential incompatibility with existing programs; limitation to Targeted Workstation Platforms; added Complexity of Application Deployment; difficulty in Supporting External Parties Efficiently

Using an internet browser model overcame these limitations. In many respects advent of the Internet (and associated technologies) made the invention practical by providing an efficient cost/effective channel for delivering applications based on the invention to mass markets while allowing us to target any computing platform that supports HTML/HTTP standard.

In the early stages of investment design we considered custom approaches to data formats. At that time, it was not clear that XML would become the dominant standard that it is today. Proprietary data formats could provide a potentially smaller size for faster data transfer; a proprietary data structure hindering competitor reverse engineering and a semantic and syntactic model tailored to invention requirements.

The decision to adopt an ‘industry standard’ data format has proven to be most advantageous since most major application vendors now support XML as a native data format greatly simplifying invention integration with third-part vendors of Customer Relationship Management (CRM), Portal and other systems with which the invention must be linked. XML also facilitated rapid implementation of a Web Service model based on the Simple Object Access Protocol (SOAP) as shown in FIG. 2—item 20.

To prepare the invention for use a financial institution needs to install the software onto a number of computing devices. The first environment to be set up is the Rule Builder environment which governs the advice that is eventually delivered by Advisors to customers, call center operators to customers, directly to customers and other methods of delivery.

To install the Rule Builder the application must be installed on a ‘Rule Builder Workstation’ (2). It is also necessary to initialize the Rule Builder database (3). This database is the repository for all of the storage requirements for the ‘Rule Builder Workstation’ (2) and is initialized through the appropriate database scripts. The rule builder application is installed from data media though an automated installation script.

Once the ‘Rule Builder Workstation’ (2) is installed and functional one or more ‘Financial Service Analysts (1) will use the rule builder to input the financial advice rules, pick lists, constants, User Interface text, etc. All access occurs via an institutions ‘Internal Corporate Network’ (6). We recommend that this connection not occur over a non-secure network (such as the public Internet) due to the sensitive nature of the application, although it is technically possible. Once the ‘Financial Service Analysts’ (1) are satisfied that the various advice rules have been correctly engineered and entered into the ‘Rule Builder Workstation’ (2) they will initiate a transfer of the information to a ‘Staging/QA Server’. It is also possible for an organization to directly publish to a production environment but we recommend that a separate QA environment be set up so that compliance and QA staff (5) can verify the correct operating of the platform before moving the rules into production. We feel it is critical that compliance approved the advice or an organization could mistakenly publish erroneous algorithms into the active financial advisory process.

To further describe the steps above our invention allows a non-technical individual to make fundamental changes to the financial advice that an organization delivers through our invention over multiple deliver channels. Not only does the platform provide for the consistent delivery of advice across multiple channels, it more importantly eliminates the need for software development to make changes to the advice rules. This is especially important in the current global environment where risks are much more apparent and organizations cannot wait for their software development staff (or an external company such as Monetaire) to change advice rules. If there is a significant global event our invention allows financial service institutions to immediately response by allowing the ‘Financial Service Analysts’ (1) to make the changes themselves, publish the changes and facilitate changes to the production environment. This can be measures in minutes and hours, not weeks and months as is typical with a software development change.

If this is a new installation and not a modification to an existing installation then there are installation steps that must occur before the new rules can be installed. On each ‘Monetaire Production Server’ (7) the base Monetaire platform must be installed. This includes all of the subcomponents, User Interface Templates, code libraries and default initialization files. This is performed by running our automated installation routine usually from a CD. In addition the ‘Monetaire Production Database’ (13) must be initialized. We provide default scripts that will initialize the database for the platform.

Once the ‘Compliance/Quality Assurance’ (5) staff and authorized the correctness of the rules (as published by the ‘Financial Service Analysis’ (1)) they can authorize the ‘Information Technology Staff’ (8) to migrate the files to the production environment. Only the modified files are required to be migrated to the production servers. We have architected our solution to run across multiple web servers as illustrated by the ‘Monetaire Production Server 1’ (7). Note that the diagram allows for N number of servers. Our invention can run effectively on hundreds of servers if that is required to meet the user demand. This was achieved by our unique method of managing user ‘session state’ as describe in more detail in this document.

Once the changes have been migrated from the ‘Staging/QA Server’ (4) by the ‘Information technology Staff’ (8) the institution will immediately be running the new advisory rules (and/or other changes initiated by the FSA). This is compelling as all channels of distribution will immediately be running the new advisory rules as modified (or initialized). This is important as the rule changes could be urgent and initiated as a direct result of some external event that necessitates maximum speed and reaction by the financial service institution.

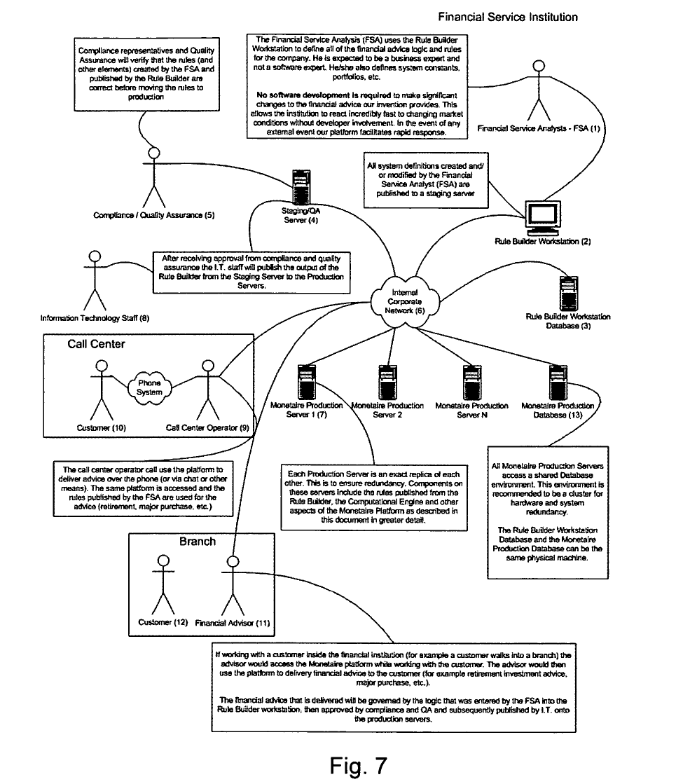

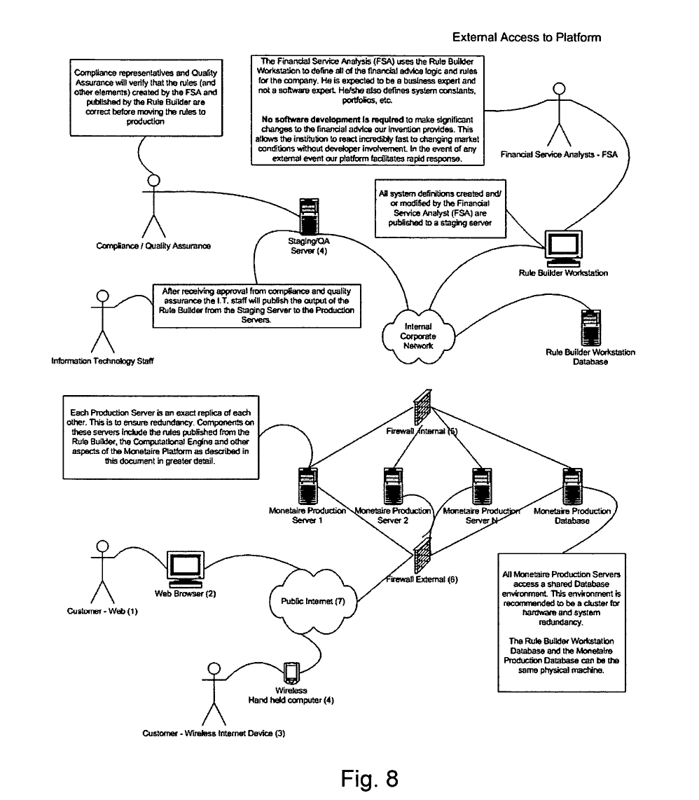

FIG. 7 illustrates the use of the invention by internal staff of the financial services institution. It does not illustrate the use of the invention over the public Internet. This is described in FIG. 8. There are two primary channels for advice delivery for internal users: Call Center Operators and Financial Advisors. There are also other delivery channels that are supported by the platform that are not included on the diagram such as Kiosks that could sit in a branch (for customer self-service), secure wireless devices help by internal staff and Virtual Private Network initiated uses of the platform. These are fully supported and their omission from the diagram is purely to reduce complexity of the figure and to aid in the understanding of the image,

A ‘Financial Advisor’ (11) will access the platform through the ‘Internal Corporate Network’ (6). This communication will occur using the hyper-text transfer protocol (http) and/or the hyper-text transfer protocol secure (https) for secure communications. Other devices, such as wireless telephones, wireless PDA's, etc. are suitable for use, provided the appropriate protocol is available to the network through which the central ‘Monetaire Production Server’ (7) is connected. It is important to point out that a user of the platform will not necessary access only 1 production server. Through the use of load-balancer technology the user could actually move between servers with each application page request. This maximizes the scalability of our solution. However this capability is not enabled unless the appropriate load balancing technology is in place. In FIG. 7 we show the ‘Customer’ (12) as being present in the physical branch with the Financial Advisor (11). For example, a customer could walk into the financial institution branch, sit down with the advisor and receive financial advice that is driven from our platform. Specific advice could be related to meeting the customer's retirement objectives, major purchase goals, paying for a child's education, paying off customer debt or other financial goals. Again the rules that drive the advice as delivered are maintained by the ‘Financial Service Analyst’ (1) through the ‘Rule Builder Workstation’ (2). It is not mandatory that the customer be present however. The advisor could access a customer's records (if he has the appropriate permissions) and generate the appropriate advice which could then be communicated to the customer at a later time via email, phone or other communication method.

Another important interaction shown on FIG. 7 is the Call Center. A ‘Customer’ (10) could initiate a phone call to a call center and request financial advice related to the previously stated goals (retirement, major purchase, etc.). The ‘Call Center Operator’ (9) would access the platform using the hyper-text transfer protocol (http) or other devices, such as wireless telephones, wireless PDA's, etc. are suitable for use, provided the appropriate protocol is available to the network through which the central ‘Monetaire Production Server’ (7) is connected. This access occurs in exactly the same manner as previously described for the ‘Financial Advisor’ (11). However it is possible that the financial institution would like a different user interface for the ‘Call Center Operator’ (11) then the ‘Financial Advisor’. This is completely supported by the invention. For example, a limited subset of functionality might be appropriate for a call center operator if they do not have the appropriate credentials to deliver financial advice. They might be limited to only basic advice giving and account balance requests. This is configurable based on the desires of the financial institution.

In FIG. 8 we illustrate the use of the invention through the Internet channel. This varies from FIG. 7 in that a customer can access the platform without the help or assistance from an employee of the financial institution. This is commonly referred to as a ‘self-service’ delivery mechanism and is very cost effective for the financial institution as no advisor or call center staff member is required in the delivery of advice. It is important to point out that exactly the same platform is accessed. This is not a separate platform. Therefore all of the rules that were defined are equally applicable to the self-service channel. A major innovation of our invention is the fact that a financial service institution can become self-sufficient and rapidly modify key rules across all delivery channels, either internal or external.

In FIG. 8 we show a ‘customer’ (1) accessing the platform using a ‘web browser’ (2). This communication will occur using the hyper-text transfer protocol (http) and/or the hyper-text transfer protocol secure (https) for secure communications. The user will access the platform to receive financial advice on the previously described modules (retirement, major purchase, etc.). The customer may also have the capability of viewing account balances with the financial institution, performing financial calculations, viewing marketing material and other capabilities are deemed necessary by the financial services organization. We allow the financial institution to modify the user interface for external users if they wish. For example, the interface for a self-service customer might be dramatically different from the interface shown to a financial advisor. The advisor may have a much denser screen willed with news items, reminders, action items, etc. A customer may only see a subset of the information and perhaps information that is not present on the advisor's desktop. Again we support the desires of the financial institution in how information is presented.

Alternatively a customer could access the platform using any device that supports Internet standards such as a ‘wireless handheld computer’ (4). Our platform can recognize that the user is on a different device and adjust the user interface appropriately. For example, some handheld devices may support a limited screen size. Using our user interface templates and customization techniques we can present a user interface that is appropriate for the size of the screen and the type of device the user is running.

Preceding outlines and flowcharts illustrate how a Financial Service Provider (FSP) applies the invention to create a Platform for use by the organization's customer. The following outline and accompanying flowcharts illustrate how the FSP's agents and/or customers use the resulting invention-based platform.

### Investment-based Platform Use Outline

The following outline describing representative steps taken by a customer using a Platform generated by the previously described Invention-based Platform Generation Process is divided into six stages. These are

Stage 1: Connecting & Profiling

Stage 2: Formulating Investment Plan

Stage 3: Implementing Investment Plan

Stage 4: Setting Reporting and Alert Criteria

Stage 5: Conducting Periodic Reviews

Stage 1: Connecting & Profiling

Initiating Agent or Customer Interaction with Invention-based Platform. Agent Guided Interaction:

Compliance & Marketing Notices

Search for a Customer

Customer Identification/Selection

Web Based Client Interaction

Client Welcome Screen

Register Now

Registered Client Sign On

Processing Execution Only Customers

Developing Financial Profile

Basic Financial Profile—From CRM

Initial Financial Situation Description

Non-salary and Tax Rates

Assets at FSP and Other Institutions

Determining Risk Profile

Experience & Attitude Toward Risk

Market Interest & Risk Tolerance

Investment Exposure & Product Disclaimers

Portfolio Recommendation

Ranking Financial Needs

Personalized Advice and Goals Priority Setting

Defining Goal For Selected Needs Such as:

Retirement

Major Purchase

Education

Insurance

Stage 2: Formulating Investment Plan

Creating Plan to Fund Selected Need

Current Resources to be Applied to Goal

Planned Future Funding

Evaluating Plan Result Against Goal

Asset Allocation

Funding Risk & Return

Determining Goal/Plan Result “Gap”—Short Fall Exists

Gap Analysis Produces Short Fall

Assessing Ways to Remedy Shortfall

Potential Remedial Actions

Revising Plan to Resolve Funding Gap

Recommended Asset Allocation

Evaluating Revised Plan Result Against Goal—Reduced Short Fall

Gap Analysis View

Asset Allocation View

Risk & Return View: Current vs. Recommended Allocation

Assessing Further Ways to Eliminate Remaining Shortfall

Additional Remedial Actions

Revising Plan to Resolve Remaining Funding Gap

Choose Alternative Asset Allocation

Evaluating Plan Results Against Goal—Plan Now Over Funded

Plan Structure Summary

Plan Performance Summary

Assessing Ways to Use Excess Funds

Consider Other Ways to Remedy Shortfall

Stage 3: Implementing Investment Plan

Examining Proposed Allocation

Selected Allocation

Required Rebalancing to achieve Selected Allocation

Evaluating Recommended Products

Recommended Product Presentation

Comparative Product Display

Detailed Product Information:

Comparative Performance

Statistics and Disclaimers

Stage 4: Setting Reporting and Alert Criteria

Setting Reporting Structure & Frequency

Report Preferences

Establishing Report Delivery Preferences

Presentation Mode and Format

IF Customer is Eligible—Defining Alert Generation Criteria

Define Portfolio Alert Generation Criteria

Establishing Alert Delivery Preferences

Presentation Mode and Format

Stage 5: Conducting Periodic Reviews

Producing Tailored Periodic Report

Investment Plan Overview

Future Value Estimation—Band Widths

Model Portfolio Performance

Client Portfolio Performance

Goal Implications Goal Plan Short Fall

Current and Recommended Asset Allocation

Recommended Actions

Conducting Optional Interactive Agent/Customer Review

Expectations at Last Review

Model Portfolio Performance Since Last Review

Client Portfolio Performance Since Last Review

Optional Product Performance Since Last Review

Optional Performance Since Inception

Stage 6 Tracking Goal and Generating Alerts

Producing Tailored Alert Message

Format and Content per Prior Customer Specifications

### Investment-based Platform Use Illustration

Processes described in the preceding outline are illustrated in seven flowcharts presented on the following pages. These are:

Overview: Six Stages of Invention-based Platform Use

Stage 1: Connecting & Profiling

Stage 2: Formulating Investment Plan

Stage 3: Implementing Investment Plan

Stage 4: Setting Reporting and Alert Criteria

Stage 5: Conducting Periodic Reviews

### Rule Builder Life-Cycle Additional Content

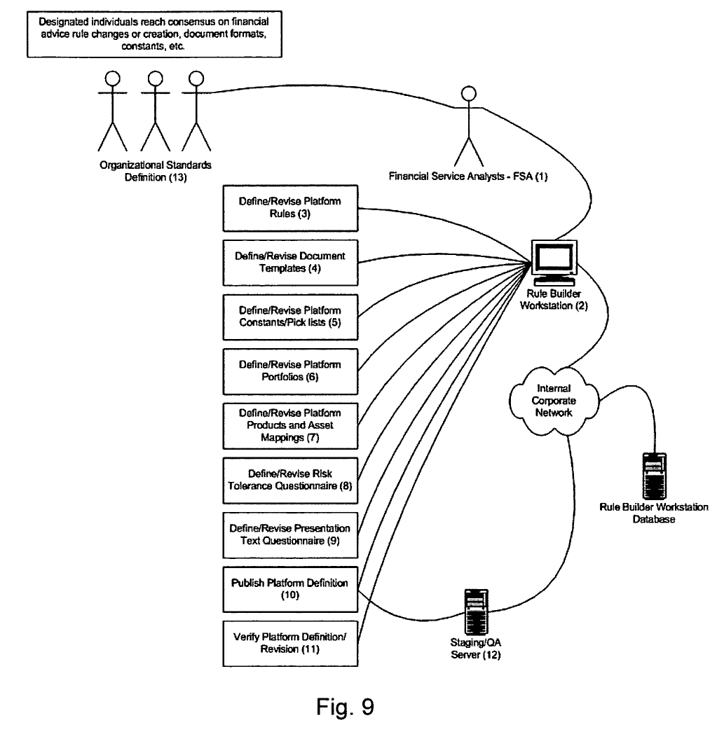

FIG. 9 illustrates the life cycle of the Rule Builder. It is assumed that there will be one or more Financial Service Analysts (FSAs) (1) who will operate the Rule Builder Workstation (2). In many cases there will be meetings held by the organization to discuss the standards, rules, templates, etc. that will be entered and supported by the platform. Some organizations will form groups of specialists and/or subject matter experts who will determine these standards. This is represented by the ‘Organizational Standards Definition’ (13) process. The important point is that the Rule Builder Workstation (2) controls the platform in a very powerful way. Fundamental financial advice rules are maintained by the Rule Builder Workstation (2) so it is critical that what is entered and used by the organization is in line with the desired policies, procedures and standards of the organization.

The first step of the Rule Builder workstation is the definition of the platform's rules. This is shown as the ‘Define/Revise Platform Rules’ (3). An example would be a rule that results in a recommended investment portfolio for a given customer. The organization may wish, for example, to base the recommended investment portfolio on two factors: the customer's risk profile score and the time horizon for the financial goal. The logic might in a very simple case might result in the following rule:

If (investment time horizon is less than 3 years) OR (customer is very conservative) Then

Use the conservative Portfolio

Else

Use the Aggressive Portfolio

End

When the logic has been agreed upon and entered the FSA uses the Rule Builder Workstation to drag and drop the appropriate metadata elements into the appropriate logical relationships. In the example, Time Horizon is a customer indicated datum that is carried in the XML document with the customer's information. Risk Tolerance is the result of a calculation algorithm in the Platform Controller based on the customer's answers to a Risk Profile Questionnaire (which itself is a creation of the Rule Builder Workstation as discuss later in this document).

Another example of a rule could be the logic to determine the eligibility to offer a home equity loan product. The organization could easily modify this rule as they contracted or expanded their policies on initiating loans. The rule could state:

If (Credit Score is >600) and (Desired Loan Amount<=(Property Market Value minus outstanding Property Debt)*0.85) then

Recommend Home Equity Loan

Else

Do not recommend Home Equity Loan

The organization could then easily modify their corporate loan policies by changing the rule above. For example if they wanted to make it easier to obtain a loan they could increase the 0.85 multiplier to say 0.95. They could also reduce the credit score requirements to acquire a loan. Alternatively they could reduce the multiplier of 0.85 to 0.75 and/or increase the credit score requirement to make it more difficult to qualify for the loan.

Another important phase of the Rule Builder is the definition of all presentation materials. This is represented by the ‘Define/Revise Document Templates’ (4) process. For example, an organization may have standard letter formats, presentation slides, fax templates and/or other forms of standardized communication. These are entered in the Rule Builder and can then be used throughout the organization. In defining the document templates we allow for rules to be called and the result of the rule to be inserted into the document template. An easy example of this would be determining the greeting format. The rule could state:

If (Gender is Male) then

Return “Dear Mr. [LastName]”

Else

If (Marital Status is Single) then

Return “Dear Ms. [Last Name]”

Else

Return “Dear Mrs. [Last Name]”

This provides for an extremely powerful way for an organization to leverage the Rule Builder to streamline communications and the standards/templates they wish to use. It significantly reduces the administrative overhead of an advisor manually creating communication elements, therefore increasing his or her productivity. These document templates can be defined as part of the ‘Organizational Standards Definition’ (13). In addition to determining content, rules can be defined that include or exclude entire sections of a document. For example, certain paragraphs in a letter may only be relevant to individuals who own their own businesses. This can be determined by a simply rule that checks for this status.

In addition to the logic rules defined with the Rule Builder there are also constants and pick list items defined as part of the process. This is represented by ‘Define/Revise Platform Constants/Pick lists’ process. For example, a company might have a toll-free number that they wish to display on the platform. This can be defined as a constant and then referred to in all areas of the platform. This makes it much easier to maintain the platform when information changes. By simply modifying the constant all areas of the platform that reference that constant will automatically be updated. This is equally true for the pick lists. A pick list is simply a group of related items such as countries, languages or currencies. For example a version of the platform might only support US Dollar and Deutschemark as currencies. The introduction of the EURO as a currency could simply be added in the Rule Builder as a new pick list element and all areas which show a currency list would automatically be updated to include the new entry. This is equally applicable for the removal of entries.

The next step in the Rule Builder life cycle is the definition of portfolios. This is represented by ‘Define/Revise Platform Portfolios’ (6) process. Many financial service organizations have standard portfolios of assets such as ‘aggressive growth portfolio’ or a ‘conservative investor portfolio’. These portfolios are defined in terms of asset classes (cash, bond, equity for example) and the percent allocation in each asset class. This area of the rule builder allows the organization to enter their standard portfolios and then refer to them in rules, documents, or other areas of the platform. For example, an organization may have an aggressive portfolio with the following characteristics:

US Equities 85%

Fixed Income 10%

Cash 5%

There could be many ‘standard’ portfolios defined as well as groups of related portfolios. For example an organization may want a completely different set of portfolios for European investors then for US Investors. This is fully supported by the Rule Builder. When an organization wants to modify their definition of any portfolio they can simply edit the asset class allocation in the rule builder and publish the changes. We support a multi-tiered mapping scheme for portfolios which includes high level assets and sub-level assets if required. For example, an organization may want to further define the aggressive portfolio with investing styles, market capitalization, fixed income duration, or other dimensions. For example the above example could be further defined as:

US Equities 85%
Large Cap Growth: 50%

Mid Cap Value: 50%

Fixed Income 10%
High Yield Intermediate Term: 10%

Investment Grade Long Term: 50%
Investment Grade Short Term: 40%

Cash 5%

Money Market 100%

The Rule Builder allows an organization to dynamically change their portfolio definitions as often as they like. If market conditions were to change for example the definition of an ‘aggressive’ portfolio could be quickly modified. If the organization wanted to reduce the risk of an aggressive portfolio for example they could increase the cash and bond percentages and reduce the equity percentages. This empowers the organization to be incredibly reactive and nimble.

In addition to the definition of portfolios the Rule Builder provides for the calculation and/or manual entry of statistical information about each portfolio. For example we need to represent the investment returns and volatility of a portfolio. If there is historical asset class information then we can perform a quantitative analysis and store the results. If historical information is not available then the information can be entered. Sample descriptive information includes:

Nominal Rate of Return

Real Rate of Return (after inflation rate of return)

Standard Deviation

Minimum Case Return

Maximum Case Return

Expected Return

1, 3, 5 and 10 year returns

Sharpe Ratio

Other Measures as Required by the Organization

Many financial service organizations will generate revenue from the sale of financial products. As the next phase the Rule Builder allows for the definition of these products and the mapping of products to relevant asset classes. This is represented as ‘Define/Revise Platform Products and Asset Mappings’ (7) process. This step is very powerful as it allows organization to define the products and also the preferences for product recommendations. For example, if a user is recommended the aggressive portfolio as described above they might need to purchase mutual funds to implement the strategy. For example, for the ‘Large Cap Growth’ asset class there could be Mutual Fund X, Mutual Fund Y and Mutual Fund Z as possible products to fulfill the asset class holding requirement. The Rule Builder facilitates not only the mapping of these funds but their relative ranking in terms of recommendations. Product Z might be what the organization wishes to promote this week but next week they could prefer product X. It is also possible to assign rules to the recommendation process where certain products are only recommended to individuals who meet some defined criteria (say total net worth for example). This is a powerful way for an organization to control in a consistent and controlled manner the product recommendations that are made and easily change the rules and standards associated with product recommendations.

As the next step the Rule Builder defines the organization's risk tolerance questionnaire(s). This is required to understand the risk profile of a potential investor. This risk tolerance questionnaire is critical to ensure that appropriate advice is being given. For example a ‘conservative’ investor should not in many cases be recommended an ‘aggressive’ portfolio. The way we determine that a user is ‘conservative’ is through the risk tolerance questionnaire. For example, the rule builder allows for questions with various answers to be selected. Here is an example:

In general, what will your reaction be if your investment suddenly drops in value?

A) Sell it to prevent further losses

B) Partially sell it to prevent further losses

C) I would hold the investment

D) Buy more (if it was attractive at a higher price, it looks even better at the current price)

Each answer is assigned a weight. With a series of questions we can sum the selected answers and determine a weighted score. This score is then often the basis for the definition of a customer's risk tolerance. The Rule Builder allows for the easily definition and maintenance of these questions, their scores and the rules that determine the outcome of the questionnaire. This is show as ‘Define/Revise Risk Tolerance Questionnaire’ (8) process. An organization may have multiple questionnaires that are relevant for different types if individuals. The Rule Builder fully supports defining multiple questionnaires and assigning rules that determine the appropriate questionnaire for an individual at run-time.

In many areas of the platform there are textual elements that change fairly often. For example an organization may have a ‘marketing message of the day’ or ‘compliance alert’ that needs to be easily updated without the involvement of skilled HTML designers. The Rule Builder provides for this through the ‘Define/Revise Presentation Text Questionnaire’ (9) process. This operates much like the constants definition in that the text can be referenced in other parts of the platform. An update to a text element will automatically be reflected in any area that references the text element. For example an organization could have a sales alert that states:

All sales of product X this week will result in an extra 5% commission.

This capability allows the organization to easily and efficiently publish information in a variety of presentation formats. This includes the Internet, Intranet, presentation documents or other delivery channels.

Throughout this process the FSA can publish the modifications to a ‘Staging/QA Server’ (12) for testing the modification. This can occur with each change or in batch at the end of the entry/modification process. This publishing process is represented by ‘Publish Platform Definition’ (10). This publishing occurs using the HTTP or HTTPS protocol and delivers the appropriate files from the local Rule Builder Workstation to the designated ‘Staging/QA Server’ (12). The ‘Staging/QA Server’ (12) is assumed to be properly configured. This means it has a correct installation of the Monetaire platform performed via installation media using our automated installation utility.

The Rule Builder maintains an audit trail of all changes that take place. This is critical for audit and compliance purposes. In the event of a dispute our audit trail provides an unambiguous record of all rules, their previous versions and any modifications that occurred. Every time a change is published the previous version is kept. This is true of all aspects of the platform. We maintain extensive audit trails and are able to report on past edits and modifications.

Once all elements of the platform have been specified and published we can initiation the verification process. This is represented by ‘Verify Platform Definition/Revision’ (11) process. The initial verification would occur by the FSA before alerting the Compliance and Quality Assurance groups to perform their own separate verification. Assuming the changes are accepted the modifications can be migrated to production as shown in other diagrams and discussed in other sections of this document.

We claim:

1. A wealth management platform for global financial advice delivery, comprising:
a rule builder workstation, the rule builder workstation including a code generator for converting rule definitions and communication module output to instruction sets,
a computation engine for providing an object-oriented software abstraction of a financial transaction,
a user interface for permitting a user to access the wealth management platform from a user terminal in electronic communication with the wealth management platform via a distributed or local network, and
at least one module selected from the group consisting of a needs identification module, a debt management module, a product selection and advisory module, a goal tracking and review module, a tailored portfolio generation module, a proactive communication module, a customized proposal generation module, a retirement advice module, a major purchase module, an education module, an insurance module, a wealth building module, a generic goal module, and a wealth group profiling module.

2. The system of claim 1, wherein the rule builder workstation includes, or accesses a database including, at least one meta data selected from the group consisting of rule expression abstractions, system constants, pick lists, model portfolio abstractions, investment and debt products, risk questionairre abstractions, text element definitions, report and document mappings, platform initialization data, rule builder configuration data, and rule builder archives.

3. A method for delivering financial advice, comprising
defining platform rules,
defining document templates,
defining platform constants and pick lists,
defining platform portfolios,
defining platform product and asset mappings,
defining risk tolerance questionnaires,
publishing platform definitions,
verifying platform definitions,
storing definitions in a rule builder database,
accessing the rule builder database from a rule builder workstation, in response to a query for financial advice.

4. A method for delivering financial advice, comprising
connecting to a wealth management platform via a local or distributed network,
establishing a financial profile,
formulating an investment plan,
implementing an investment plan, and
setting report and alert criteria,
wherein the financial profile is entered into a rule builder workstations, the rule builder workstation accesses a rule builder database and computation engine, and financial advice generated is the rule builder to form the investment plan.
